(19) United States
(12) Patent Application Publication
(10) Pub. No.: US 2016/0285788 A1
(43) Pub. Date: Sep. 29, 2016

(54) Method and Apparatus for Preprogrammed Informational Reply to an Identified Communications Connection Request

(71) Applicant: ANTONIO SABAREZ, II, SEASIDE, CA (US)

(72) Inventor: ANTONIO SABAREZ, II, SEASIDE, CA (US)

(21) Appl. No.: 14/668,279

(22) Filed: Mar. 25, 2015

(51) Int. Cl. H04L 12/58; H04M 3/487; H04W 4/14

(52) U.S. Cl. CPC H04L 51/02; H04W 4/14; H04M 3/487; H04L 51/36; H04L 51/38

(57) ABSTRACT

A system and method to enable the designation of previously recorded responses to communications originating from a known contact for the purpose of facilitating individualized contact, particularly in the commercial and professional spaces. A plurality of contact addresses may be added to a single contact profile to allow for multiple communication methods per contact. A plurality of communication methods may be utilized including, but not limited to, telephone calls, text messages and email transmissions. Media files, documents, images and audio files, for example, may be attached to the previously recorded responses to communications. The designated response may further contain GPS location data, which may be included in the previously recorded response transmission.

### FIELD OF THE INVENTION

The present invention relates to the relatedness of one or more communications devices. More particularly, the invented method relates to the associating of individualized contact identifications with custom, user-created messages (audio or text). The invention further relates to the field of identification and transmission of a GPS signal.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Previous methods of generating automatic responses to incoming calls, text messages, or email transmissions have proved inefficient because the automatic responses as they currently exist are too unilateral. In an “attention economy,” wherein the necessity exists of being consistently and deeply available to customers, clients and other business associates, such generalized response messages such as voicemail or automated email responses are not sufficient to retain the interest of current or potential associates. General automated responses also prove inefficient because they cannot include confidential information of a kind that may need to be communicated between, for example, attorneys and clients or healthcare providers and their patients. Individuals in sales, for example, have an urgent need to be responsive to customer desires, questions and concerns, but cannot necessarily be constantly available. A lack of total availability on the part of such an individual may result in short- and/or long-term pecuniary loss.

There is therefore a long-felt need to provide a method and system that provide increased efficiencies in the area of customized automatic response messages.

### SUMMARY AND OBJECTS OF THE INVENTION

Towards these objects and other objects that will be made obvious in light of the present disclosure, a system and method are provided that enable an “attention economy” asset. The method of the present invention (hereinafter “the invented method”) comprises the generation and assignment of individualized response messages to a remotely initiated communication from known contacts. In a preferred embodiment of the invented method, the remotely initiated communication may be a telephone call. A user may create a personalized audio message for a known contact, containing information specific to that known contact. When a communications device receives a telephone call from the known contact, and when the user does not pick up the telephone call, the communications device may transmit the previously recorded audio response to the known contact initiating the communication.

According to an alternate embodiment of the invented method, the initiated communication may optionally be a text message. A user may designate a previously written text message containing information relevant to a known contact, and the previously written text message may be transmitted by the communications device upon receiving a text message from the known contact.

In a further alternate embodiment of the invented method, the remotely initiated communication may optionally be an email. A user may designate a previously written email containing information relevant to a known contact, and the previously written email may be transmitted by the communications device upon receiving an email from the known contact.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

These, and further features of the invention, may be better understood with reference to the accompanying specification and drawings depicting the preferred embodiment, in which:

FIG. 1 is a diagram of an electronics communication network, comprising a client, a communications device, a server and a plurality of contacts;

FIG. 2 is a flowchart of an aspect of the invented method whereby the communications device identifies a known contact of origin for an incoming phone call and transmits an automatic audio message to the known contact from which the communication originates;

FIG. 3 is a flowchart describing a client side process whereby the client of FIG. 1 sends telephone call identification information to the server and receives a designated custom message for transmission to the device from which the telephone call originates from the server;

FIG. 4 is a flowchart describing a server side process whereby the server of FIG. 1 determines which of a plurality of custom messages to transmit to a designated contact identification address in response to a telephone call;

FIG. 5 is a flowchart of a further aspect of the invented method whereby the communications device identifies the origin of an incoming text message or email transmission and transmits a predetermined text message or email transmission to the device from which the initial text message or email transmission originates;

FIG. 6 is a flowchart of an aspect of the invented method whereby the client of FIG. 1 transmits text message or email transmission information to the server and receives from the server a designated custom message for transmission to the device from which the text message or email transmission originates;

FIG. 7 is a flowchart of an additional aspect of the invented method whereby the server of FIG. 1 determines which of a plurality of custom messages to transmit to a designated contact identification request in response to a text message or an email transmission;

FIG. 8 is a flowchart of a yet additional aspect of the invented method whereby the communications device identifies the origin of an incoming video call and transmits a predetermined video message response to the device from which the communication originated;

FIG. 9 is a flowchart of a yet additional aspect of the invented method whereby the client of FIG. 1 transmits information concerning a designated video call to the server and receives from the server a designated custom video message for transmission to the device from which the video call originated;

FIG. 10 is a flowchart of a further aspect of the invented method whereby the server of FIG. 1 determines which of a plurality of custom video messages to transmit to a designated contact identification request;

FIG. 11 is a flowchart of a further aspect of the invented method whereby the communications device identifies the origin of an incoming communication and transmits a predetermined set of profile information to the device from which the communication originated;

FIG. 12 is a flowchart of a further aspect of the invented method whereby the client of FIG. 1 transmits information concerning a designated communication to the server and receives from the server a designated custom set of profile information;

FIG. 13 is a flowchart of a yet further aspect of the invented method whereby the server of FIG. 1 determines which of a plurality of custom sets of profile information to transmit to a designated contact identification request;

FIG. 14 is a flowchart of a yet further aspect of the invented method whereby the communications device identifies the origin of an incoming text message or email transmission and transmits a predetermined text message or email transmission to the device from which the initial text message or email transmission originate, along with the current GPS location data of the communications device;

FIG. 15 is a flowchart of a yet further aspect of the invented method whereby the communications device identifies the origin of an incoming text message or email transmission and transmits a predetermined text message or email transmission to the device from which the initial text message or email transmission originate, along with previously designated GPS location data of the communications device;

FIG. 16 is a flowchart describing a contact side process whereby one of the plurality of contacts of FIG. 1 initiates a telephone call, a text message or an email transmission, and receives a custom, previously determined response;

FIG. 17 is a flowchart of a yet further aspect of the invented method whereby the communications device attaches a media file with a custom message to a designated contact;

FIG. 18 is a block diagram of the communications device of FIG. 1;

FIG. 19 is a block diagram of the client of FIG. 1;

FIG. 20 is a block diagram of the server of FIG. 1;

FIG. 21 is a block diagram of an exemplary first contract profile;

FIGS. 22A-22D are block diagrams of exemplary incoming communications;

FIG. 23 is a block diagram of an exemplary general response message;

FIG. 24 is a block diagram of an exemplary first custom audio response message;

FIG. 25 is a block diagram of an exemplary first custom textual response message, with optional audio, visual, video, document and/or GPS location attachment(s); and

FIG. 26 is a block diagram of an exemplary first custom video response message.

### DETAILED DESCRIPTION

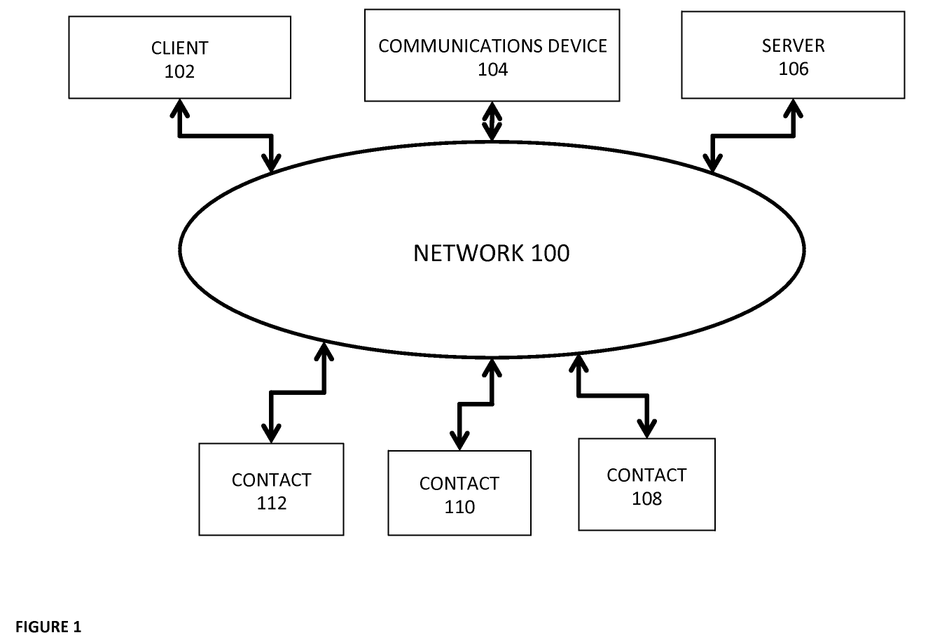

Referring now generally to the Figures, and particularly to FIG. 1, FIG. 1 is a diagram of an electronic communications network 100, comprising a client 102, a communications device 104, a server 106 and a plurality of contacts 108 through 112.

The communications device 104, client 102 and server 106 preferably comprise a database management system software (“DBMS”) 104A, 102A and 106A, respectively. The communications device DBMS 104A, the client DBMS 102A, and the server DBMS 106A may be or comprise one or more prior art database management systems including, but not limited to, an ORACLE DATABASE™ database management system marketed by Oracle Corporation, of Redwood City, Calif.; an MQSERIES™ database management system marketed by SyBase, Inc. of Dublin, Calif.; a Database 2 ™, also known as DB2™, relational database management system as marketed by IBM Corporation of Armonk, N.Y.; a Microsoft SQL Server™ relational database management system as marketed by Microsoft Corporation of Redmond, Wash.; MySQL™ as marketed by Oracle Corporation of Redwood City, Calif.; and a MONGODB™ as marketed by MongoDB, Inc. of New York City, USA; and the POSTGRESQL™ open source object-relational database management system.

It is understood that the client 102, the communications device 104 and the server 106 may be a software program hosted and/or enabled by, or may be or comprise a bundled computer software and hardware product such as but not limited to, (a.) a network-communications enabled THINKPAD WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS VISTA™, WINDOWS 7 ™, or WINDOWS 8 ™ operating system marketed by Microsoft Corporation of Redmond, Wash.; (d.) a MACBOOK PRO™ personal computer as marketed by Apple, Inc. of Cupertino, Calif.; (e.) an IPHONE G4 ™ internet enabled cellular telephone marketed by Apple, Inc., of Cupertino, Calif.; (d.) an IPAD™ tablet computer marketed by Apple, Inc., of Cupertino, Calif.; (f.) a GALAXY™ internet enabled cellular telephone marketed by Samsung, Inc. of Suwon, Republic of Korea; or (g.) other suitable computational system or electronic communications device known in the art capable of executing contact identification and responding message transmission.

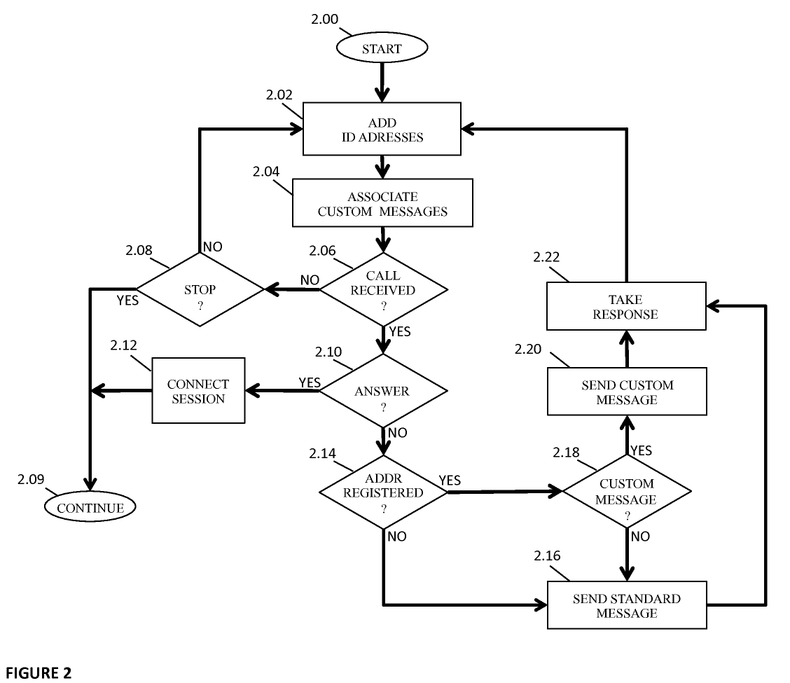

Referring now generally to the Figures, and particularly to FIG. 2, FIG. 2 is a flowchart of an aspect of the invented method whereby the communications device 104 identifies a contact 108-112 of origin for an incoming telephone call 113 and transmits an automatic audio message 114 to the contact 108-112 from which the incoming telephone call 113 originates. In step 2.02 the communications device 104 adds contact identifier addresses CON.ID.001-CON.ID.N to designated contact profiles CON.PROF.001-CON.PROF.N. A single contact profile CON.PROF.001-CON.PROF.N may optionally contain a plurality of contact identifier addresses CON.ID.001-CON.ID.N, for example if a single individual is associated with a home telephone number, a cellular telephone number, and a workplace telephone number, all three identifiers may be associated with the individual's contact profile CON.PROF.001-CON.PROF.N. In step 2.04 a user 115 records a plurality of custom audio recordings AUD.RESP.001-AUD.RESP.N, using any suitable software audio recording program known in the art, and the communications device 104 associates the custom audio recordings AUD.RESP.001-AUD.RESP.N with the contact identifier addresses CON.ID.001-CON.ID.N. In step 2.06 the communications device 104 determines whether a telephone call 113 has been received. When the determination in step 2.06 is negative, i.e. the communications device 104 has not received a call, the communications device 104 advances to step 2.08. In step 2.08 the communications device 104 determines whether to terminate the process. When the communications device 104 determines to terminate the process in step 2.08, the communications device 104 advances to step 2.09, wherein the communications device 104 advances to alternate processes. Alternatively, when the communications device 104 determines in step 2.08 not to terminate the process, the communications device 104 returns to step 2.02, wherein the loop of steps 2.02 through 2.08 is executed as necessary. In the alternative, when the communications device 104 determines in step 2.06 that a call has been received, the communications device 104 advances to step 2.10, wherein the communications device 104 determines whether to answer the incoming telephone call 113. When the communications device 104 determines in step 2.10 to answer the incoming telephone call 113, the communications device 104 connects the session in step 2.12. Upon execution of step 2.12, the communications device 104 proceeds to step 2.09, wherein the process is terminated.

Alternatively, when the determination in step 2.10 is negative, and the communications device 104 determines not to answer the incoming telephone call 113, the communications device 104 determines in step 2.14 whether the address associated with the incoming phone call is registered in the list of contacts in the communications device 104. When the determination in step 2.14 is positive, the communications device 104 determines in step 2.18 whether a custom audio recording AUD.RESP.001-AUD.RESP.N is associated with the known contact 108-112 initiating the telephone call 113. When the determination in either step 2.14 or step 2.18 is negative, the communications device 104 advances to step 2.16, wherein the communications device 104 transmits the standard, universal message MSG.GEN.001-MSG.GEN.N to the address associated with the incoming phone call. The communications device 104 subsequently advances to step 2.22, wherein a response from the contact 108-112 is taken. Alternatively, when the determination in step 2.18 is positive, the communications device 104 transmits the custom audio recording AUD.RESP.001-AUD.RESP.N associated with the known contact identification CON.ID.001-CON.ID.N. When the communications device 104 has completed the execution of step 2.20, the communications device 104 advances to step 2.22, wherein a response from the contact 108-112 is taken. The communications device 104 subsequently returns to step 2.02 and executes the loop of steps 2.02 through 2.22 as necessary.

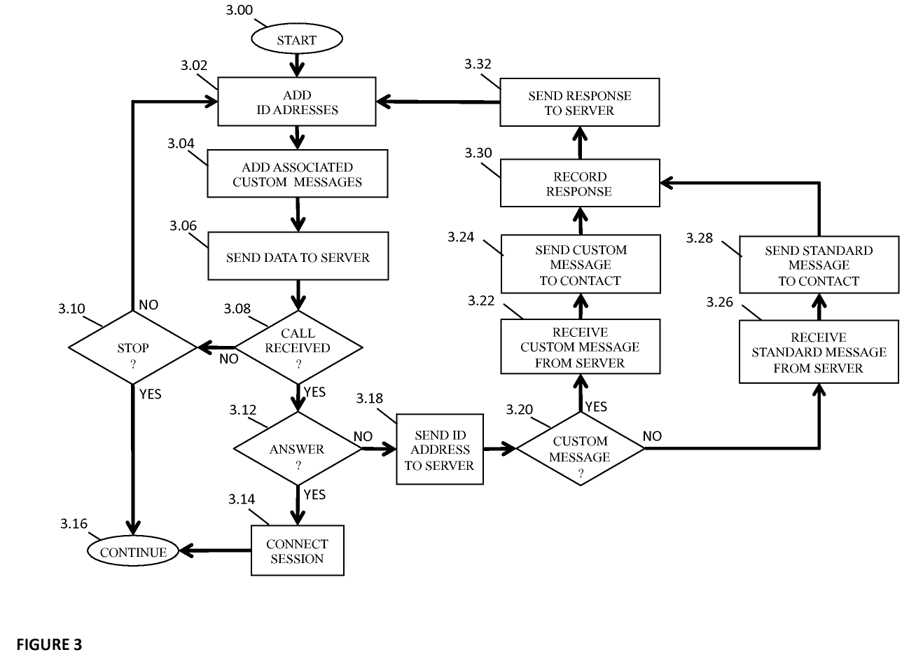

Referring now generally to the Figures, and particularly to FIG. 3, FIG. 3 is a flowchart of a yet further aspect of the invented method, describing a client side process whereby the client 102 of FIG. 1 sends telephone call 113 identification information to the server 106 and receives from the server 106 a custom response message RESP.001-RESP.N for transmission to the device from which the telephone call 113 originates. In step 3.02 the client 102 adds contact identification addresses CON.ID.001-CON.ID.N to the contact profiles CON.PROF.001-CON.PROF.N. In step 3.04 the user 115 creates custom response messages RESP.001-RESP.N, and the client 102 associates the custom response messages RESP.001-RESP.N to the contact identification addresses CON.ID.001-CON.ID.N added in step 3.02. In step 3.06 the client 102 transmits the data collected in steps 3.02 through 3.04 to the server 106. In step 3.08 the client 102 determines whether a telephone call 113 has been received. When the determination in step 3.08 is negative, the client 102 advances to step 3.10 wherein the client 102 determines whether to terminate the process. When the client 102 determines in step 3.10 to terminate the process, the client 102 proceeds to step 3.16, wherein the client 102 continues to alternate processes. Alternatively, when the determination in step 3.10 is negative, the client 102 returns to step 3.02 and executes the loop of steps 3.02 through 3.16 as necessary. In the alternative, when the client 102 determines in step 3.08 that a call has been received, the client 102 advances to step 3.12. In step 3.12 the client 102 determines whether to answer the incoming telephone call 113. When the client 102 determines in step 3.12 to answer the incoming telephone call 113, the client 102 connects the session in step 3.14, and subsequently continues to alternate processes in step 3.16.

Alternatively, when the client 102 determines in step 3.12 not to answer the incoming telephone call 113, the client 102 advances to step 3.18, wherein the client 102 transmits the contact identification addresses CON.ID.001-CON.ID.N to the server 106. In step 3.20 the client 102 determines whether to transmit a custom message RESP.001-RESP.N to the contact identification addresses CON.ID.001-CON.ID.N from which the telephone call 113 originated. When the determination in step 3.20 is positive, the client 102 receives a custom response message RESP.001-RESP.N from the server 106 in step 3.22. in step 3.24, the client 102 transmits the custom response message RESP.001-RESP.N to the contact identification addresses CON.ID.001-CON.ID.N from which the telephone call 113 originated. In the alternative, when the determination in step 3.20 is negative, the client 102 receives the standard response message MSG.GEN.001-MSG.GEN.N from the server in step 3.26 and transmits the standard response message MSG.GEN.001-MSG.GEN.N to the contact identification addresses CON.ID.001-CON.ID.N from which the telephone call 113 originated in step 3.28. The client 102 proceeds either from the execution of step 3.24, or from the execution of step 3.28 to step 3.30, wherein a response to the custom response message RESP.001-RESP.N is recorded. In step 3.32 the response recorded in step 3.30 is transmitted to the server 106. The client 102 subsequently returns to step 3.02, and re-executes the loop of steps 3.02 through 3.32 as necessary.

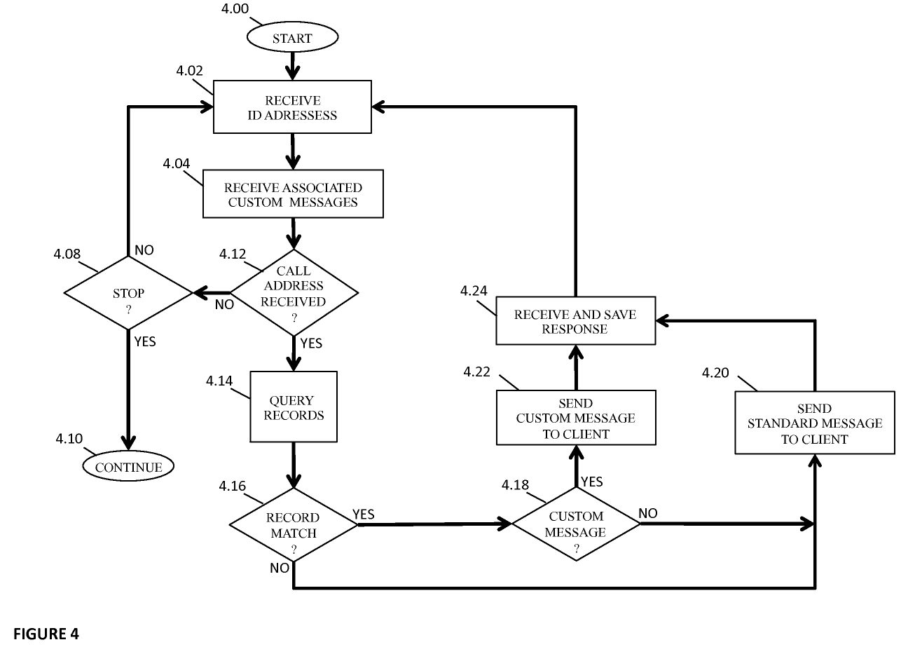

Referring now generally to the Figures and particularly to FIG. 4, FIG. 4 is a flowchart of a yet further embodiment of the invented method whereby the server 106 of FIG. 1 receives contact identification addresses CON.ID.001-CON.ID.N and associates them a plurality of contact profiles PROF.CON.001-PROF.CON.N. In step 4.02 the server 106 receives contact identification addresses CON.ID.001-CON.ID.N. In step 4.04 the server 106 receives the user-created automatic response messages RESP.001-RESP.N associated with the contact identification addresses CON.ID.001-CON.ID.N received in step 4.02. In step 4.04 the server 106 determines whether the contact identification address CON.ID.001-CON.ID.N for an incoming telephone call 113 has been received. When the determination in step 4.08 is negative, the server 106 advances to step 4.08, wherein the server 106 determines whether to terminate the process. When the determination in step 4.08 is positive, the server 106 in step 4.10 continues to alternate processes. When the determination in step 4.08 is negative, the server 106 returns to step 4.02 and executes the loop of steps 4.02 through 4.12 as necessary. Alternatively, when the determination in step 4.12 is positive, the server 106 advances to step 4.14, wherein the server 106 queries the plurality of contact profiles PROF.CON.001-PROF.CON.N of contact identification addresses CON.ID.001-CON.ID.N. In step 4.16 the server 106 determines whether a record of a contact identification address CON.ID.001-CON.ID.N matched the contact identification address CON.ID.001-CON.ID.N associated with the incoming telephone call 113. When the determination in step 4.16 is positive, the server 106 advances to step 4.18, wherein the sever 106 determines whether to transmit a custom response message RESP.001-RESP.N to the client 102. When the determination in step 4.18 is positive, the server 106 transmits the custom response message RESP.001-RESP.N to the client 102 in step 4.22. In the alternative, when the determination in either step 4.16 or step 4.18 is negative, the server 106 in step 4.20 transmits the standard, general message MSG.GEN.001-MSG.GEN.N to the client 102. The server 106 advances either from the execution of step 4.22 or step 4.20 to the execution of 4.24, wherein the server 106 receives and saves a response to the custom response message RESP.001-RESP.N. The server 106 subsequently returns to step 4.02 and re-executes the loop of steps 4.02 through 4.24 as necessary.

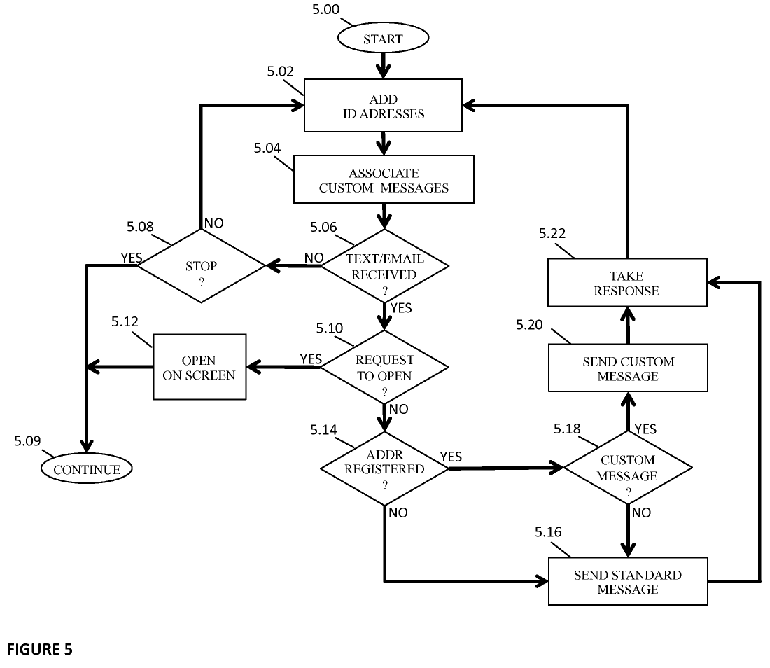

Referring now generally to the Figures and particularly to FIG. 5, FIG. 5 is a flowchart of an aspect of the invented method whereby the communications device 104 associates a custom response message RESP.001-RESP.N with a contact identification address CON.ID.001-CON.ID.N, and transmits the response message RESP.001-RESP.N to the contact identification address CON.ID.001-CON.ID.N upon reception of a text message 121 or an email transmission 122. In step 5.02 the communications device 104 adds contact identification addresses CON.ID.001-CON.ID.N to the designated contact profiles CON.PROF.001-CON.PROF.N. A single contact profile CON.PROF.001-CON.PROF.N may optionally contain a plurality of contact identifier addresses CON.ID.001-CON.ID.N, for example if a single individual is associated both a personal email address and a work email address, both identifiers may be associated with the individual's contact profile CON.PROF.001-CON.PROF.N. In step 5.04 a user 115 creates the custom response messages RESP.001-RESP.N, and the communications device 104 associates the custom response messages RESP.001-RESP.N to the contact identification addresses CON.ID.001-CON.ID.N created in step 5.02. In step 5.06 the communications device 104 determines whether a text message 121 or an email transmission 122 has been received. When the determination in step 5.06 is false, the communications device 104 advances to step 5.08, wherein the communications device 104 determines whether to terminate the process. When the communications device 104 determines in step 5.08 to terminate the process, the communications device 104 advances to step 5.09, wherein the communications device 104 continues to alternate processes. Alternatively, when the determination in step 5.08 is negative, and the communications device 104 determines not to terminate the process, the communications device 104 returns to step 5.02 and re-executes the loop of steps 5.02 through 5.12 as necessary. In the alternative, when the determination in step 5.06 is positive, i.e. when the communications device 104 determines that a text message 121 or email transmission 122 has been received, the communications device 104 advances to step 5.10, wherein it is determined whether a request to open the text message 121 or email transmission 122 has been inputted by a user. When the communications device 104 in step 5.10 determines that a user 115 has requested that the text message 121 or email transmission 122 be opened, the text message 121 or email transmission 122 is opened on the screen 120 of the communications device 104 in step 5.12. The communications device 104 subsequently advances to step 5.09, wherein the communications device 104 executes alternate processes.

Alternatively, when the communications device 104 determines in step 5.10 that no request to open the text message 121 or email transmission 122 has been received, the communications device 104 proceeds to step 5.14. In step 5.14 the communications device 104 determines whether the incoming text message 121 or email transmission 122 is associated with a known contact identification address CON.ID.001-CON.ID.N. When the communications device 104 determines in step 5.14 that the incoming text message 121 or email transmission 122 is associated with a known contact identification address CON.ID.001-CON.ID.N, the communications device 104 determines in step 5.18 whether to transmit the custom response message RESP.001-RESP.N associated with the known contact identification address CON.ID.001-CON.ID.N. Alternatively, when the determination in step 5.14 is false, or when the communications device 104 determines in step 5.18 not to transmit the custom response message RESP.001-RESP.N, the communications device 104 advances to step 5.16, wherein a general message MSG.GEN.001-MSG.GEN.N is transmitted to the address of the contact identifier from the communication originated. The communications device 104 then advances to step 5.22, wherein a reply from the known contact 108-112 to the custom response message RESP.001-RESP.N is taken. Alternatively, subsequent to a positive determination in step 5.18, the communications device 104 proceeds to step 5.20. In step 5.20 the custom response message is transmitted to the contact identification address CON.ID.001-CON.ID.N from which the communication 117 originated. The communications device 104 subsequently advances to step 5.22, wherein a reply from the known contact 108-112 to the custom message response RESP.001-RESP.N is accepted. The communications device 104 then returns to step 5.02, and re-executes the loop of steps 5.02 through 5.22 as necessary.

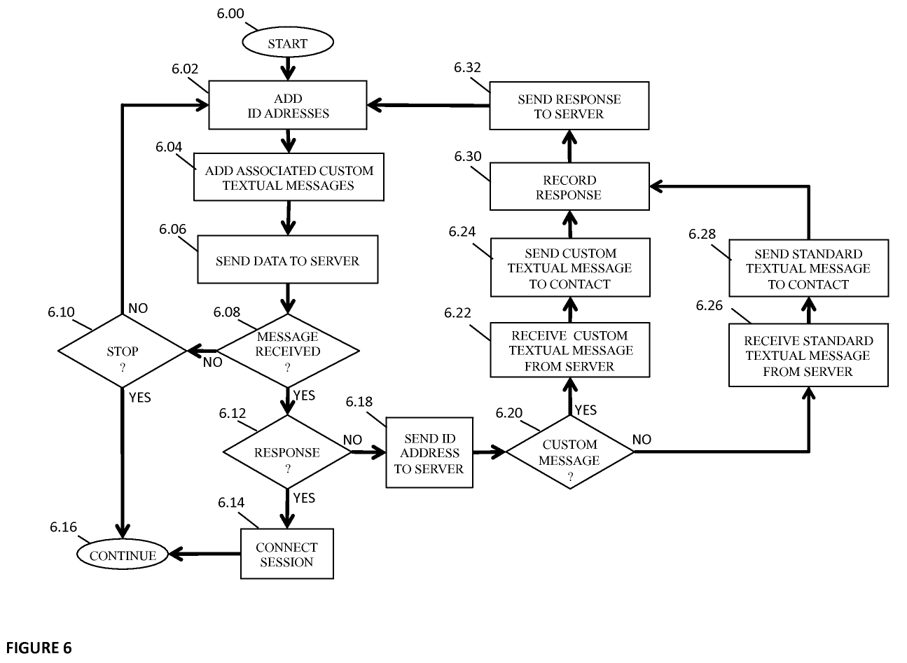

Referring now generally to the Figures, and particularly to FIG. 6, FIG. 6 is a flowchart of a yet further aspect of the invented method, describing a client side process whereby the client 102 of FIG. 1 sends text message 121 and/or email transmission 122 identification information to the server 106 and receives from the server 106 a custom textual response message TXT.RESP.001-TXT.RESP.N for transmission to the contact 108-112 device from which the text message 121 and/or email transmission 122 originated. In step 6.02 the client 102 adds contact identification addresses CON.ID.001-CON.ID.N to the contact profiles CON.PROF.001-CON.PROF.N. In step 6.04 the user 115 creates custom textual response messages TXT.RESP.001-TXT.RESP.N, and the client 102 associates the custom textual response messages TXT.RESP.001-TXT.RESP.N to the contact identification addresses CON.ID.001-CON.ID.N added in step 6.02. In step 6.06 the client 102 transmits the data collected in steps 6.02 through 6.04 to the server 106. In step 6.08 the client 102 determines whether a text message 121 and/or email transmission 122 has been received. When the determination in step 6.08 is negative, the client 102 advances to step 6.10 wherein the client 102 determines whether to terminate the process. When the client 102 determines in step 6.10 to terminate the process, the client 102 proceeds to step 6.16, wherein the client 102 continues to alternate processes. Alternatively, when the determination in step 6.10 is negative, the client 102 returns to step 6.02 and executes the loop of steps 6.02 through 6.16 as necessary. In the alternative, when the client 102 determines in step 6.08 that a text message 121 and/or email transmission 122 has been received, the client 102 advances to step 6.12. In step 6.12 the client 102 determines whether to open the incoming text message 121 and/or email transmission 122. When the client 102 determines in step 6.12 to open the incoming text message 121 and/or email transmission 122, the client 102 connects the session in step 6.14, and subsequently continues to alternate processes in step 6.16.

Alternatively, when the client 102 determines in step 6.12 not to open the incoming text message 121 and/or email transmission 122, the client 102 advances to step 6.18, wherein the client 102 transmits the contact identification addresses CON.ID.001-CON.ID.N to the server 106. In step 6.20 the client 102 determines whether to transmit a custom textual response message TXT.RESP.001-TXT.RESP.N to the contact identification addresses CON.ID.001-CON.ID.N from which the text message 121 and/or email transmission 122 originated. When the determination in step 6.20 is positive, the client 102 receives a custom textual response message TXT.RESP.001-TXT.RESP.N from the server 106 in step 6.22. in step 6.24, the client 102 transmits the custom textual response message TXT.RESP.001-TXT.RESP.N to the contact identification addresses CON.ID.001-CON.ID.N from which the text message 121 and/or email transmission 122 originated. In the alternative, when the determination in step 6.20 is negative, the client 102 receives a standard textual response message MSG.GEN.001-MSG.GEN.N from the server in step 6.26 and transmits the standard textual response message MSG.GEN.001-MSG.GEN.N to the contact identification addresses CON.ID.001-CON.ID.N from which the text message 121 and/or email transmission 122 originated in step 6.28. The client 102 proceeds either from the execution of step 6.24, or from the execution of step 6.28 to step 6.30, wherein a reply to the custom textual response message TXT.RESP.001-TXT.RESP.N from the contact 108 is recorded. In step 6.32 the reply recorded in step 6.30 is transmitted to the server 106. The client 102 subsequently returns to step 6.02, and re-executes the loop of steps 6.02 through 6.32 as necessary.

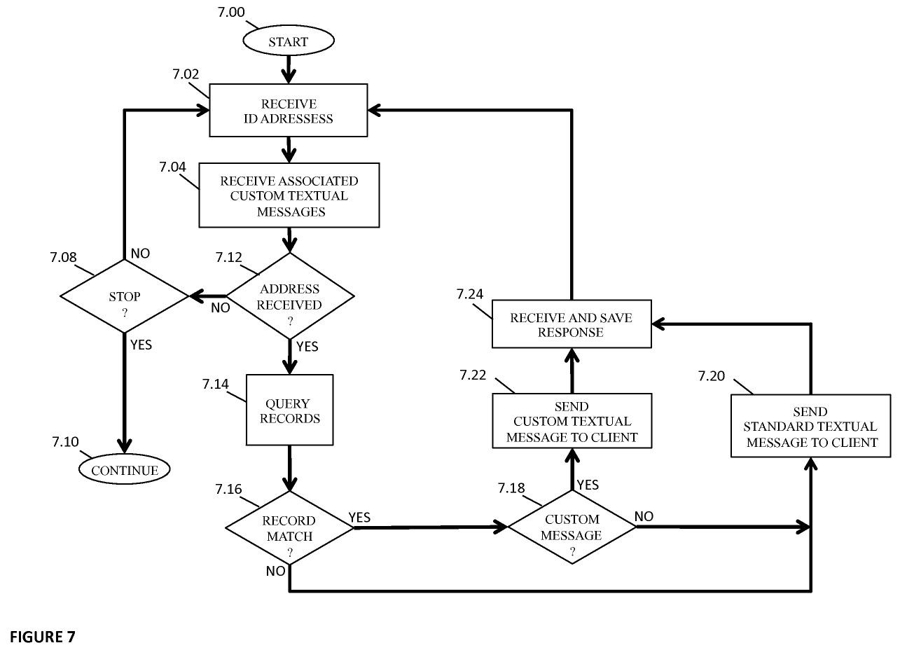

Referring now generally to the Figures and particularly to FIG. 7, FIG. 7 is a flowchart of a yet further embodiment of the invented method whereby the server 106 of FIG. 1 receives contact identification addresses CON.ID.001-CON.ID.N and associates them with records of automatic textual responses TXT.RESP.001-TXT.RESP.N. In step 7.02 the server 106 receives contact identification addresses CON.ID.001-CON.ID.N from the client 102. In step 7.04 the server 106 receives the user-created automatic textual response messages TXT.RESP.001-TXT.RESP.N associated with the contact identification addresses CON.ID.001-CON.ID.N received in step 7.02. In step 7.04 the server 106 determines whether the contact identification address CON.ID.001-CON.ID.N for an incoming text message 121 and/or email transmission 122 has been received from the client 102. When the determination in step 7.08 is negative, the server 106 advances to step 7.08, wherein the server 106 determines whether to terminate the process. When the determination in step 7.08 is positive, the server 106 in step 7.10 continues to alternate processes. When the determination in step 7.08 is negative, the server 106 returns to step 7.02 and executes the loop of steps 7.02 through 7.12 as necessary.

Alternatively, when the determination in step 7.12 is positive, the server 106 advances to step 7.14, wherein the server 106 queries the records of contact identification addresses CON.ID.001-CON.ID.N contained within the server memory 106G. In step 7.16 the server 106 determines whether a record of a contact identification address CON.ID.001-CON.ID.N matched the contact identification address CON.ID.001-CON.ID.N associated with the incoming text message 121 and/or email transmission 122. When the determination in step 7.16 is positive, the server 106 advances to step 7.18, wherein the sever 106 determines whether to transmit a custom textual response message TXT.RESP.001-TXT.RESP.N to the client 102. When the determination in step 7.18 is positive, the server 106 transmits the custom textual response message TXT.RESP.001-TXT.RESP.N to the client 102 in step 7.22. In the alternative, when the determination in either step 7.16 or step 7.18 is negative, the server 106 in step 7.20 transmits a standardized textual response message to the client 102. The server 106 advances either from the execution of step 7.22 or step 7.20 to the execution of 7.24, wherein the server 106 receives and saves a reply to the custom textual response message TXT.RESP.001-TXT.RESP.N. The server 106 subsequently returns to step 7.02 and re-executes the loop of steps 7.02 through 7.24 as necessary.

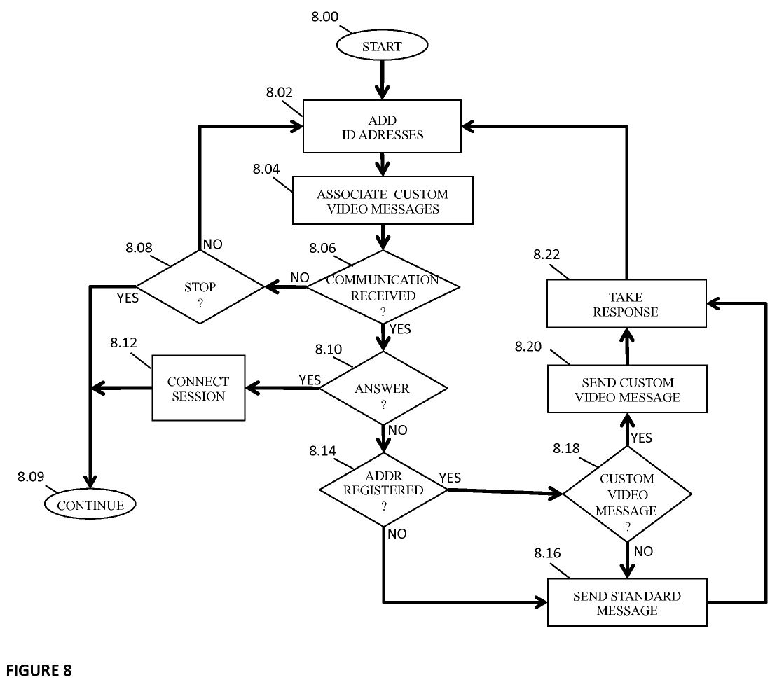

Referring now generally to the Figures, and particularly to FIG. 8, FIG. 8 is a flowchart of an aspect of the invented method whereby the communications device 104 identifies a contact 108-112 of origin for an incoming video call 123 and transmits an automatic video message 116 to the contact 108-112 from which the video call 123 originated. In step 8.02 the communications device 104 adds contact identifier addresses CON.ID.001-CON.ID.N to designated contact profiles CON.PROF.001-CON.PROF.N contained within the communications device memory 104G. In step 8.04 a user 115 records a plurality of custom video responses VID.RESP.001-VID.RESP.N, using any suitable software video recording program known in the art, and the communications device 104 associates the custom video responses VID.RESP.001-VID.RESP.N with the contact identifier addresses CON.ID.001-CON.ID.N. In step 8.06 the communications device 104 determines whether a video call 123 has been received. When the determination in step 8.06 is negative, i.e. when the communications device 104 has not received a video call 123, the communications device 104 advances to step 8.08. In step 8.08 the communications device 104 determines whether to terminate the process. When the communications device 104 determines to terminate the process in step 8.08, the communications device 104 advances to step 8.09, wherein the communications device 104 advances to alternate processes. Alternatively, when the communications device 104 determines in step 8.08 not to terminate the process, the communications device 104 returns to step 8.02, wherein the loop of steps 8.02 through 8.08 is executed as necessary. In the alternative, when the communications device 104 determines in step 8.06 that a video call 123 has been received, the communications device 104 advances to step 8.10, wherein the communications device 104 determines whether to answer the incoming video call 123. When the communications device 104 determines in step 8.10 to answer the incoming video call 123, the communications device 104 connects the session in step 8.12. Upon execution of step 8.12, the communications device 104 proceeds to step 8.09, wherein the process is terminated.

Alternatively, when the determination in step 8.10 is negative, and the communications device 104 determines not to answer the incoming video call 123, the communications device 104 determines in step 8.14 whether the contact identifier address CON.ID.001-CON.ID.N associated with the incoming video call 123 is registered in the list of contacts 108-112 in the communication device memory 104G. When the determination in step 8.14 is positive, the communications device 104 determines in step 8.18 whether a custom video recording VID.RESP.001-VID.RESP.N is associated with the known contact 108-112 initiating the video call 123. When the determination in either step 8.14 or step 8.18 is negative, the communications device 104 advances to step 8.16, wherein the communications device 104 transmits a standardized video message 116 to the address associated with the incoming video call 123. The communications device 104 subsequently advances to step 8.22, wherein a reply from the contact 108-112 is taken. Alternatively, when the determination in step 8.18 is positive, the communications device 104 transmits the custom video recording VID.RESP.001-VID.RESP.N associated with the known contact identification CON.ID.001-CON.ID.N. When the communications device 104 has completed the execution of step 8.20, the communications device 104 advances to step 8.22, wherein a reply from the contact 108-112 is taken. The communications device 104 subsequently returns to step 8.02 and executes the loop of steps 8.02 through 8.22 as necessary.

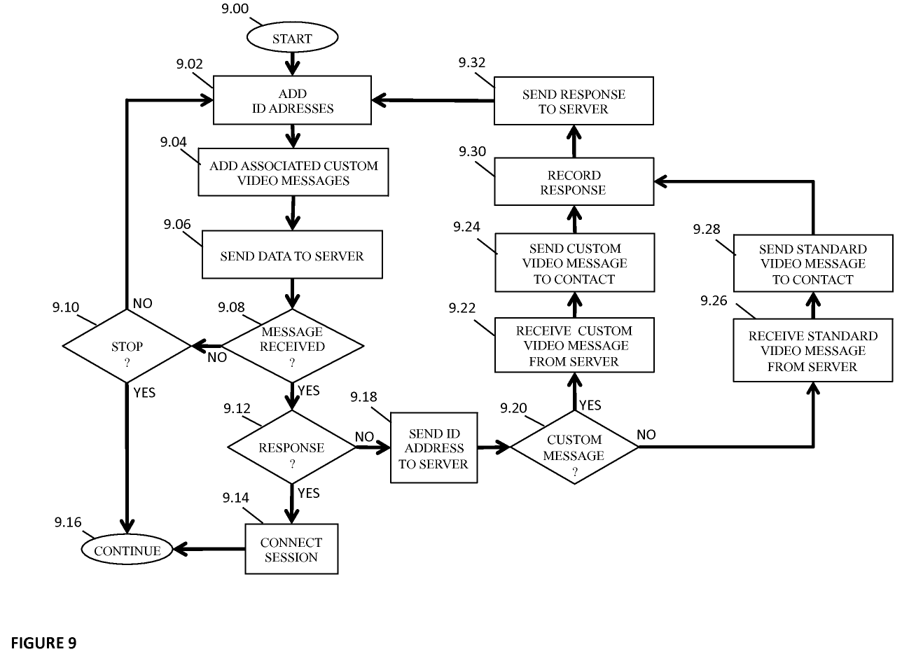

Referring now generally to the Figures, and particularly to FIG. 9, FIG. 9 is a flowchart of a yet further aspect of the invented method, describing a client side process whereby the client 102 of FIG. 1 sends video call 123 identification information to the server 106 and receives from the server 106 a custom video response message VID.RESP.001-VID.RESP.N for transmission to the contact 108-112 device from which the video call 123 originated. In step 9.02 the client 102 adds contact identification addresses CON.ID.001-CON.ID.N to the contact profiles CON.PROF.001-CON.PROF.N contained within the client memory 102G. In step 9.04 a user 115 creates custom video response messages VID.RESP.001-VID.RESP.N, and the client 102 associates the custom video response messages VID.RESP.001-VID.RESP.N to the contact identification addresses CON.ID.001-CON.ID.N added in step 9.02. In step 9.06 the client 102 transmits the data collected in steps 9.02 through 9.04 to the server 106. In step 9.08 the client 102 determines whether a video call 123 has been received. When the determination in step 9.08 is negative, the client 102 advances to step 9.10 wherein the client 102 determines whether to terminate the process. When the client 102 determines in step 9.10 to terminate the process, the client 102 proceeds to step 9.16, wherein the client 102 continues to alternate processes. Alternatively, when the determination in step 9.10 is negative, the client 102 returns to step 9.02 and executes the loop of steps 9.02 through 9.16 as necessary. In the alternative, when the client 102 determines in step 9.08 that a video call 123 has been received, the client 102 advances to step 9.12. In step 9.12 the client 102 determines whether to accept the incoming video call 123 transmission. When the client 102 determines in step 9.12 to answer the incoming video call 123, the client 102 connects the communications device 104 to the device of the known client 108-112 in step 9.14, and subsequently continues to alternate processes in step 9.16.

Alternatively, when the client 102 determines in step 9.12 not to answer the incoming video call 123, the client 102 advances to step 9.18, wherein the client 102 transmits the contact identification addresses CON.ID.001-CON.ID.N to the server 106. In step 9.20 the client 102 determines whether to transmit a custom video response message VID.RESP.001-VID.RESP.N to the contact identification addresses CON.ID.001-CON.ID.N from which the video call 123 originated. When the determination in step 9.20 is positive, the client 102 receives a custom video response message VID.RESP.001-VID.RESP.N from the server 106 in step 9.22. in step 9.24, the client 102 transmits the custom video response message VID.RESP.001-VID.RESP.N to the contact identification addresses CON.ID.001-CON.ID.N from which the video call 123 originated. In the alternative, when the determination in step 9.20 is negative, the client 102 receives a standard video response message MSG.GEN.001-MSG.GEN.N from the server in step 9.26 and transmits the standard video response message MSG.GEN.001-MSG.GEN.N to the contact identification addresses CON.ID.001-CON.ID.N from which the video call 123 originated in step 9.28. The client 102 proceeds either from the execution of step 9.24, or from the execution of step 9.28 to step 9.30, wherein a reply from the contact 108 to the custom video response message VID.RESP.001-VID.RESP.N is recorded. In step 9.32 the reply recorded in step 9.30 is transmitted to the server 106. The client 102 subsequently returns to step 9.02, and re-executes the loop of steps 9.02 through 9.32 as necessary.

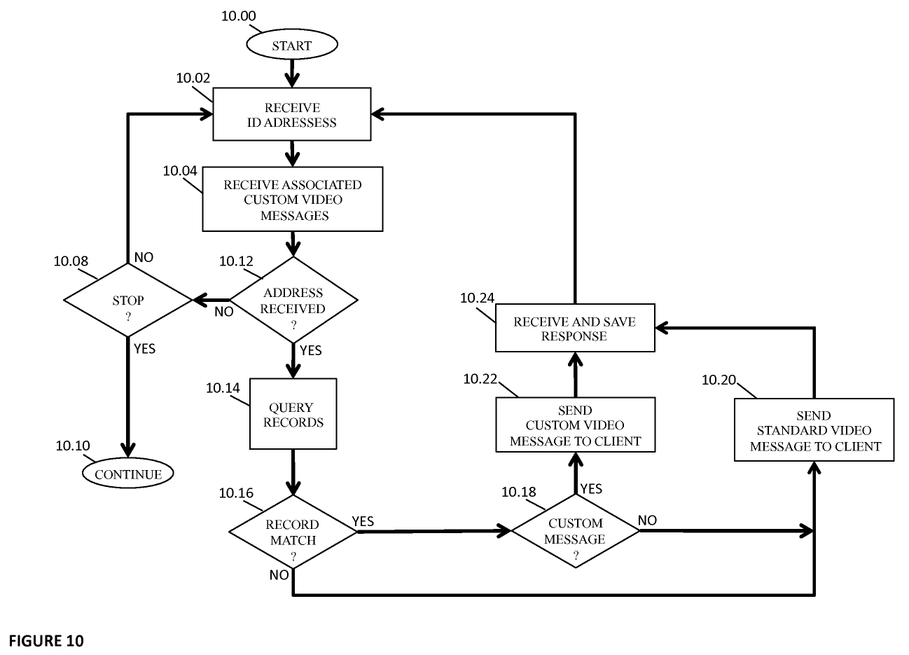

Referring now generally to the Figures and particularly to FIG. 10, FIG. 10 is a flowchart of a yet further embodiment of the invented method whereby the server 106 of FIG. 1 receives contact identification addresses CON.ID.001-CON.ID.N and associates them with records of automatic video responses VID.RESP.001-VID.RESP.N. In step 10.02 the server 106 receives contact identification addresses CON.ID.001-CON.ID.N from the client 102. In step 10.04 the server 106 receives the user-created automatic video response messages VID.RESP.001-VID.RESP.N associated with the contact identification addresses CON.ID.001-CON.ID.N received in step 10.02. In step 10.04 the server 106 determines whether the contact identification address CON.ID.001-CON.ID.N for an incoming video call 123 has been received from the client 102. When the determination in step 10.08 is negative, the server 106 advances to step 10.08, wherein the server 106 determines whether to terminate the process. When the determination in step 10.08 is positive, the server 106 in step 10.10 continues to alternate processes. When the determination in step 10.08 is negative, the server 106 returns to step 10.02 and executes the loop of steps 10.02 through 10.12 as necessary.

Alternatively, when the determination in step 10.12 is positive, the server 106 advances to step 10.14, wherein the server 106 queries the records of contact identification addresses CON.ID.001-CON.ID.N contained within the server memory 106G. In step 10.16 the server 106 determines whether a record of a contact identification address CON.ID.001-CON.ID.N matched the contact identification address CON.ID.001-CON.ID.N associated with the incoming video call 123. When the determination in step 10.16 is positive, the server 106 advances to step 10.18, wherein the sever 106 determines whether to transmit a custom video response message VID.RESP.001-VID.RESP.N to the client 102. When the determination in step 10.18 is positive, the server 106 transmits the custom video response message VID.RESP.001-VID.RESP.N to the client 102 in step 10.22. In the alternative, when the determination in either step 10.16 or step 10.18 is negative, the server 106 in step 10.20 transmits a standardized video response message to the client 102. The server 106 advances either from the execution of step 10.22 or step 10.20 to the execution of step 10.24, wherein the server 106 receives and saves a reply from the contact 108-112 to the custom video response message VID.RESP.001-VID.RESP.N. The server 106 subsequently returns to step 10.02 and re-executes the loop of steps 10.02 through 10.24 as necessary.

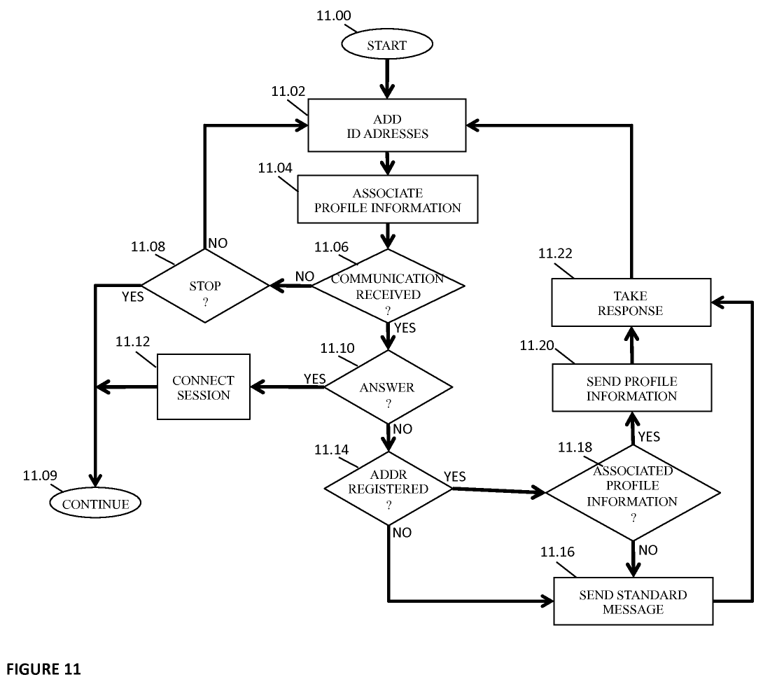

Referring now generally to the Figures, and particularly to FIG. 11, FIG. 11 is a flowchart of an aspect of the invented method whereby the communications device 104 identifies a contact 108-112 of origin for an incoming communication 117 and transmits a set of profile information to the contact 108-112 from which the communications initiation originated. The communications initiation may be, but is not limited to, an email, a message from an instant messenger service (for example, ICHAT™, marketed by Apple Inc, of Cupertino Calif.), a text message 121, or a voice over IP call. In step 11.02 the communications device 104 adds contact identifier addresses CON.ID.001-CON.ID.N to designated contact profiles CON.PROF.001-CON.PROF.N contained within the communications device memory 104G. In step 11.04 a user 115 designates a plurality of profile records, and/or a plurality of custom combinations of profile response messages PROF.RESP.001-PROF.RESP.N, and the communications device 104 associates the custom profile response messages PROF.RESP.001-PROF.RESP.N with the contact identifier addresses CON.ID.001-CON.ID.N. The profile records messages PROF.RESP.001. In step 11.06 the communications device 104 determines whether a video call 123 has been received. When the determination in step 11.06 is negative, i.e. the communications device 104 has not received a communication, the communications device 104 advances to step 11.08. In step 11.08 the communications device 104 determines whether to terminate the process. When the communications device 104 determines to terminate the process in step 11.08, the communications device 104 advances to step 11.09, wherein the communications device 104 advances to alternate processes. Alternatively, when the communications device 104 determines in step 11.08 not to terminate the process, the communications device 104 returns to step 11.02, wherein the loop of steps 11.02 through 11.08 is executed as necessary. In the alternative, when the communications device 104 determines in step 11.06 that a communication 117 has been received, the communications device 104 advances to step 11.10, wherein the communications device 104 determines whether to answer the communication. When the communications device 104 determines in step 11.10 to answer the incoming communication, the communications device 104 connects the session in step 11.12. Upon execution of step 11.12, the communications device 104 proceeds to step 11.09, wherein the process is terminated.

Alternatively, when the determination in step 11.10 is negative, and the communications device 104 determines not to answer the incoming communication, the communications device 104 determines in step 11.14 whether the contact identifier address CON.ID.001-CON.ID.N associated with the incoming communication 117 is registered in the list of contacts 108-112 in the communication device memory 104G. When the determination in step 11.14 is positive, the communications device 104 determines in step 11.18 whether a custom profile record response PROF.RESP.001-PROF.RESP.N is associated with the known contact 108-112 initiating the communication. When the determination in either step 11.14 or step 11.18 is negative, the communications device 104 advances to step 11.16, wherein the communications device 104 transmits a standardized set of profile records to the address associated with the incoming communication. The communications device 104 subsequently advances to step 11.22, wherein a reply from the contact 108-112 associated with the contact identification COND.ID.001-COND.ID.N is taken. Alternatively, when the determination in step 11.18 is positive, the communications device 104 transmits the custom set of profile response messages PROF.RESP.001-PROF.RESP.N associated with the known contact identification CON.ID.001-CON.ID.N. When the communications device 104 has completed the execution of step 11.20, the communications device 104 advances to step 11.22, wherein a reply from the contact 108-112 associated with the contact identification COND.ID.001-COND.ID.N is taken. The communications device 104 subsequently returns to step 11.02 and executes the loop of steps 11.02 through 11.22 as necessary.

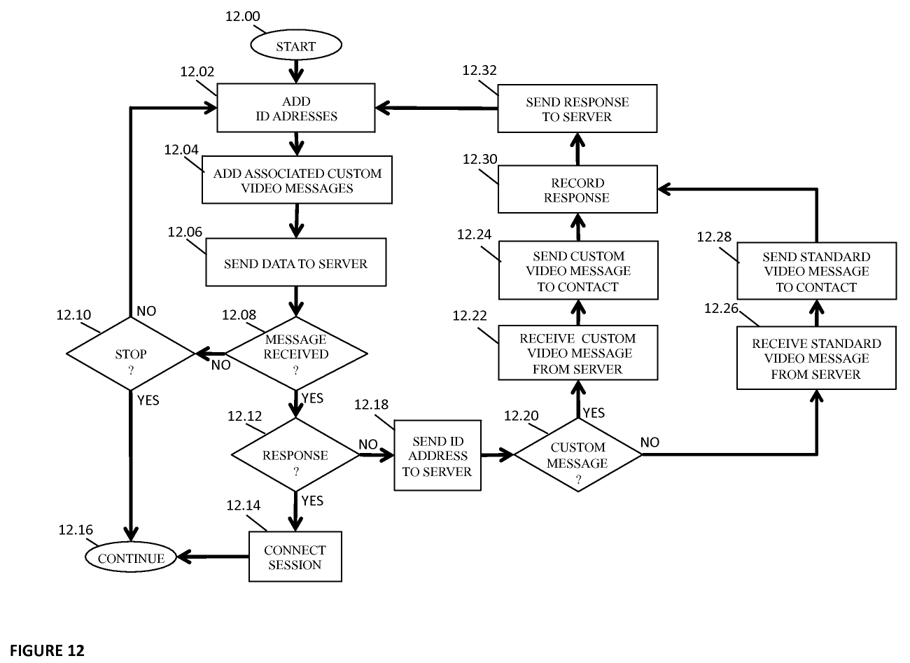

Referring now generally to the Figures, and particularly to FIG. 12, FIG. 12 is a flowchart of a yet further aspect of the invented method, describing a client side process whereby the client 102 of FIG. 1 sends communication 117 identification information to the server 106 and receives from the server 106 a custom set of profile records PROF.RESP.001-PROF.RESP.N for transmission to the contact 108-112 device from which the communication 117 originated. In step 12.02 the client 102 adds contact identification addresses CON.ID.001-CON.ID.N to the contact profiles CON.PROF.001-CON.PROF.N contained within the client memory 102G. In step 12.04 a user 115 creates custom profile response messages PROF.RESP.001-PROF.RESP.N, and the client 102 associates the custom profile response messages PROF.RESP.001-PROF.RESP.N to the contact identification addresses CON.ID.001-CON.ID.N added in step 12.02. In step 12.06 the client 102 transmits the data collected in steps 12.02 through 12.04 to the server 106. In step 12.08 the client 102 determines whether a communication 117 has been received. When the determination in step 12.08 is negative, the client 102 advances to step 12.10 wherein the client 102 determines whether to terminate the process. When the client 102 determines in step 12.10 to terminate the process, the client 102 proceeds to step 12.16, wherein the client 102 continues to alternate processes. Alternatively, when the determination in step 12.10 is negative, the client 102 returns to step 12.02 and executes the loop of steps 12.02 through 12.16 as necessary. In the alternative, when the client 102 determines in step 12.08 that a communication 117 has been received, the client 102 advances to step 12.12. In step 12.12 the client 102 determines whether to accept the incoming communication. When the client 102 determines in step 12.12 to answer the incoming communication, the client 102 connects the session in step 12.14, and subsequently continues to alternate processes in step 12.16.

Alternatively, when the client 102 determines in step 12.12 not to answer the communication, the client 102 advances to step 12.18, wherein the client 102 transmits the contact identification addresses CON.ID.001-CON.ID.N to the server 106. In step 12.20 the client 102 determines whether to transmit a custom profile response message PROF.RESP.001-PROF.RESP.N to the contact identification addresses CON.ID.001-CON.ID.N from which the communication 117 originated. When the determination in step 12.20 is positive, the client 102 receives a custom profile response message PROF.RESP.001-PROF.RESP.N from the server 106 in step 12.22. In step 12.24, the client 102 transmits the custom profile response message PROF.RESP.001-PROF.RESP.N to the contact identification addresses CON.ID.001-CON.ID.N from which the communication 117 originated. In the alternative, when the determination in step 12.20 is negative, the client 102 receives a standard profile response message from the server in step 12.26 and transmits the standard profile response message to the contact identification addresses CON.ID.001-CON.ID.N from which the communication 117 originated in step 12.28. The client 102 proceeds either from the execution of step 12.24, or from the execution of step 12.28 to step 12.30, wherein a reply from the contact 108 to the custom profile response message PROF.RESP.001-PROF.RESP.N is recorded. In step 12.32 the reply recorded in step 12.30 is transmitted to the server 106. The client 102 subsequently returns to step 12.02, and re-executes the loop of steps 12.02 through 12.32 as necessary.

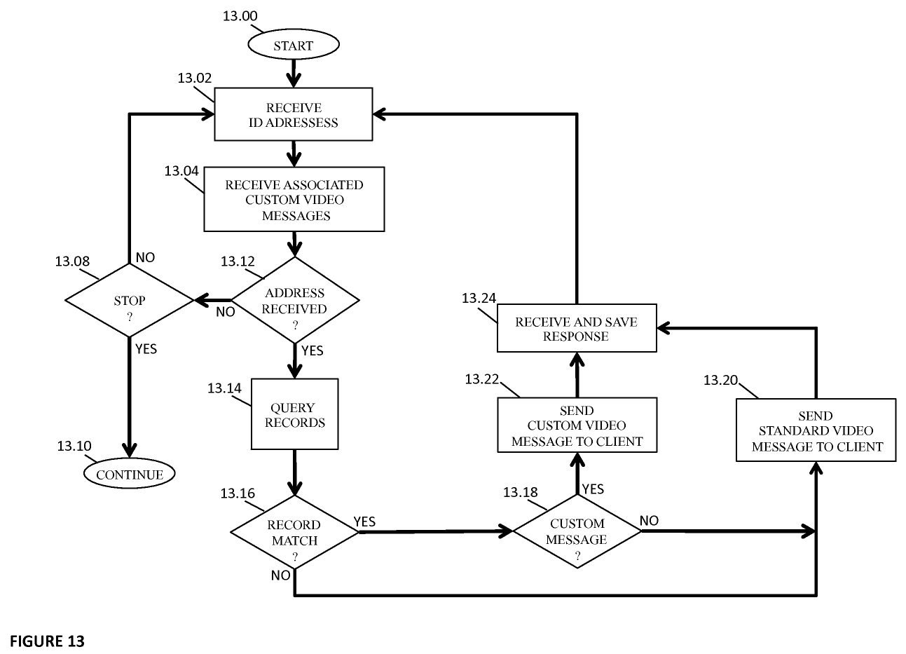

Referring now generally to the Figures and particularly to FIG. 13, FIG. 13 is a flowchart of a yet further embodiment of the invented method whereby the server 106 of FIG. 1 receives contact identification addresses CON.ID.001-CON.ID.N and associates them with records of automatic profile response message PROF.RESP.001-PROF.RESP.N. In step 13.02 the server 106 receives contact identification addresses CON.ID.001-CON.ID.N from the client 102. In step 13.04 the server 106 receives the user-created automatic profile response message PROF.RESP.001-PROF.RESP.N associated with the contact identification addresses CON.ID.001-CON.ID.N received in step 13.02. In step 13.04 the server 106 determines whether the contact identification address CON.ID.001-CON.ID.N for an incoming communication 117 has been received from the client 102. When the determination in step 13.08 is negative, the server 106 advances to step 13.08, wherein the server 106 determines whether to terminate the process. When the determination in step 13.08 is positive, the server 106 in step 13.10 continues to alternate processes. When the determination in step 13.08 is negative, the server 106 returns to step 13.02 and executes the loop of steps 13.02 through 13.12 as necessary.

Alternatively, when the determination in step 13.12 is positive, the server 106 advances to step 13.14, wherein the server 106 queries the records of contact identification addresses CON.ID.001-CON.ID.N contained within the server memory 106G. In step 13.16 the server 106 determines whether a record of a contact identification address CON.ID.001-CON.ID.N matched the contact identification address CON.ID.001-CON.ID.N associated with the incoming communication. When the determination in step 13.16 is positive, the server 106 advances to step 13.18, wherein the sever 106 determines whether to transmit a custom profile response message PROF.RESP.001-PROF.RESP.N to the client 102. When the determination in step 13.18 is positive, the server 106 transmits the custom profile response message PROF.RESP.001-PROF.RESP.N to the client 102 in step 13.22. In the alternative, when the determination in either step 13.16 or step 13.18 is negative, the server 106 in step 13.20 transmits a standardized profile response message to the client 102. The server 106 advances either from the execution of step 13.22 or step 13.20 to the execution of 13.24, wherein the server 106 receives and saves a reply to the custom profile response message PROF.RESP.001-PROF.RESP.N. The server 106 subsequently returns to step 13.02 and re-executes the loop of steps 13.02 through 13.24 as necessary.

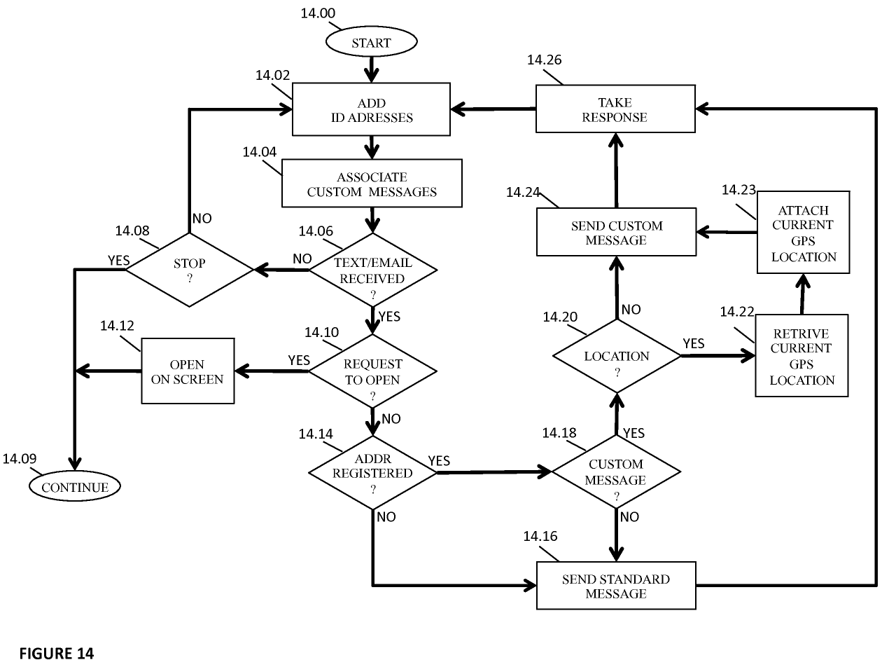

Referring now generally to the Figures, and particularly to FIG. 14, FIG. 14 is a flowchart of a further aspect of the invented method whereby GPS location data of the current location GPS.LOC.001-GPS.LOC.N of the communications device 104 is attached to an outgoing custom response message RESP.001-RESP.N. In step 14.02 the communications device 104 adds contact identification addresses CON.ID.001-CON.ID.N to the designated contact profiles CON.PROF.001-CON.PROF.N. In step 14.04, the user 115 creates custom response messages RESP.001-RESP.N, and the communications device 104 associates the custom response messages RESP.001-RESP.N to the contact identification addresses added in step 14.02. In step 14.06 the communications device 104 determines whether a text message 121 or an email transmission 122 has been received. When the determination in step 14.06 is false, the communications device 104 advances to step 14.08, wherein the communications device 104 determines whether to terminate the process. When the communications device 104 determines in step 14.08 to terminate the process, the communications device 104 advances to step 14.09, wherein the communications device 104 continues to alternate processes. Alternatively, when the determination in step 14.08 is negative, and the communications device 104 determines not to terminate the process, the communications device 104 returns to step 14.02 and re-executes the loop of steps 14.02 through 14.09 as necessary. In the alternative, when the determination in step 14.06 is positive, i.e. when the communications device 104 determines that a text message 121 or email transmission 122 has been received, the communications device 104 advances to step 14.10, wherein it is determined whether a request to open the text message 121 or email transmission 122 has been inputted by a user 115. When the communications device 104 in step 14.10 determines that the user 115 has requested that the text message 121 or email transmission 122 be opened, the text message 121 or email transmission 122 is opened on the screen of the communications device 104 in step 3.12. The communications device 104 subsequently advances to step 14.09, wherein the communications device 104 executes alternate processes.

Alternatively, when the communications device 104 determines in step 14.10 that no request to open the text message 121 or email transmission 122 has been received, the communications device 104 proceeds to step 14.14. In step 14.14 the communications device 104 determines whether the incoming text message 121 or email transmission 122 is associated with a known contact identification address CON.ID.001-CON.ID.N. When the communications device 104 determines in step 14.14 that the incoming text message 121 or email transmission 122 is associated with a known contact identification address CON.ID.001-CON.ID.N, the communications device 104 determines in step 14.18 whether to transmit the custom response message RESP.001-RESP.N associated with the known contact identification address CON.ID.001-CON.ID.N. Alternatively, when the determination in step 14.14 is false, or when the communications device 104 determines in step 14.18 not to transmit the custom response message RESP.001-RESP.N, the communications device 104 advances to step 14.16, wherein a standard response message MSG.GEN.001-MSG.GEN.N is transmitted to the address of the contact identification address CON.ID.001-CON.ID.N from the communication 117 originated. The communications device 104 then advances to step 14.26, wherein a response to the custom response message RESP.001-RESP.N is taken. Alternatively, subsequent to a positive determination in step 14.18, the communications device 104 proceeds to step 14.20. In step 14.20 the communications device 104 determines whether a GPS location GPS.LOC.001-GPS.LOC.N may be retrieved. When the determination in step 14.20 is positive, the communications device 104 advances to step 14.22, wherein the current GPS location GPS.LOC.001-GPS.LOC.N is retrieved. The current GPS location GPS.LOC.001-GPS.LOC.N is attached to the custom response message RESP.001-RESP.N in step 14.23. Alternatively, when the determination in step 14.20 is negative, or upon completion of step 14.22, the communications device 104 proceeds to step 14.24, wherein the custom response message RESP.001-RESP.N is transmitted. The communications device 104 subsequently advances to step 14.26, wherein a response to the custom response message RESP.001-RESP.N is accepted. The communications device 104 then returns to step 14.02 and re-executes the loop of steps 14.02 through 14.26 as necessary.

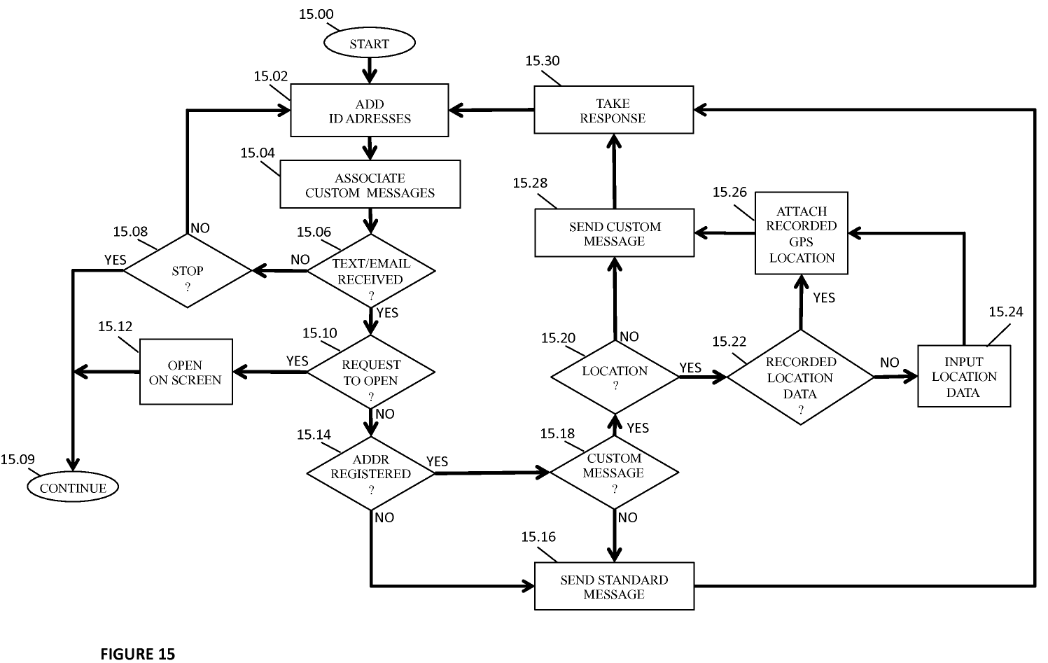

Referring now generally to the Figures, and particularly to FIG. 15, FIG. 15 is a flowchart of a further aspect of the invented method whereby GPS data of a user-designated location GPS.USR.001-GPS.USR.N is attached to an outgoing custom response message RESP.001-RESP.N. In step 15.02 the communications device 104 adds contact identification addresses CON.ID.001-CON.ID.N to the designated contact profiles CON.PROF.001-CON.PROF.N. In step 15.04, the user 115 creates custom response messages RESP.001-RESP.N, and the communications device 104 associates the custom response messages RESP.001-RESP.N to the contact identification addresses added in step 15.02. In step 15.06 the communications device 104 determines whether a text message 121 or an email transmission 122 has been received. When the determination in step 15.06 is false, the communications device 104 advances to step 15.08, wherein the communications device 104 determines whether to terminate the process. When the communications device 104 determines in step 15.08 to terminate the process, the communications device 104 advances to step 15.09, wherein the communications device 104 continues to alternate processes. Alternatively, when the determination in step 15.08 is negative, and the communications device 104 determines not to terminate the process, the communications device 104 returns to step 15.02 and re-executes the loop of steps 15.02 through 15.09 as necessary. In the alternative, when the determination in step 15.06 is positive, i.e. when the communications device 104 determines that a text message 121 or email transmission 122 has been received, the communications device 104 advances to step 15.10, wherein it is determined whether a request to open the text message 121 or email transmission 122 has been inputted by a user. When the communications device 104 in step 15.10 determines that a user has requested that the text message 121 or email transmission 122 be opened, the text message 121 or email transmission 122 is opened on the screen of the communications device 104 in step 3.12. The communications device 104 subsequently advances to step 15.09, wherein the communications device 104 executes alternate processes.

Alternatively, when the communications device 104 determines in step 15.10 that no request to open the text message 121 or email transmission 122 has been received, the communications device 104 proceeds to step 15.14. In step 15.14 the communications device 104 determines whether the incoming text message 121 or email transmission 122 is associated with a known contact identification address CON.ID.001-CON.ID.N. When the communications device 104 determines in step 15.14 that the incoming text message 121 or email transmission 122 is associated with a known contact identification address CON.ID.001-CON.ID.N, the communications device 104 determines in step 15.18 whether to transmit the custom response message RESP.001-RESP.N associated with the known contact identification address CON.ID.001-CON.ID.N. Alternatively, when the determination in step 15.14 is false, or when the communications device 104 determines in step 15.18 not to transmit the custom response message RESP.001-RESP.N, the communications device 104 advances to step 15.16, wherein a standard response message is transmitted to the address of the contact identifying address CON.ID.001-CON.ID.N from the communication 117 originated. The communications device 104 then advances to step 15.26, wherein a response to the custom response message RESP.001-RESP.N is taken. Alternatively, subsequent to a positive determination in step 15.18, the communications device 104 proceeds to step 15.20. In step 15.20 the communications device 104 determines whether a GPS location may be retrieved GPS.USR.001-GPS.USR.N. When the determination in step 15.20 is positive, the communications device 104 advances to step 15.22, wherein it is determined whether a GPS location datum GPS.USR.001-GPS.USR.N has been previously recorded. When the determination in step 15.22 is negative, the communications device 104 receives a data location input from the user 115 of the communications device 104. Upon execution of step 15.24, or alternatively when the determination in step 15.22 is positive, the communications device 104 advances to step 15.26, wherein the recorded GPS location data GPS.USR.001-GPS.USR.N is attached to the custom response message RESP.001-RESP.N. In the alternative, when the determination in step 15.20 is negative, or upon completion of step 15.26, the communications device 104 proceeds to step 15.28, wherein the custom response message RESP.001-RESP.N is transmitted. The communications device 104 subsequently advances to step 15.30, wherein a response to the custom response message RESP.001-RESP.N is accepted. The communications device 104 then returns to step 15.02 and re-executes the loop of steps 15.02 through 15.30 as necessary.

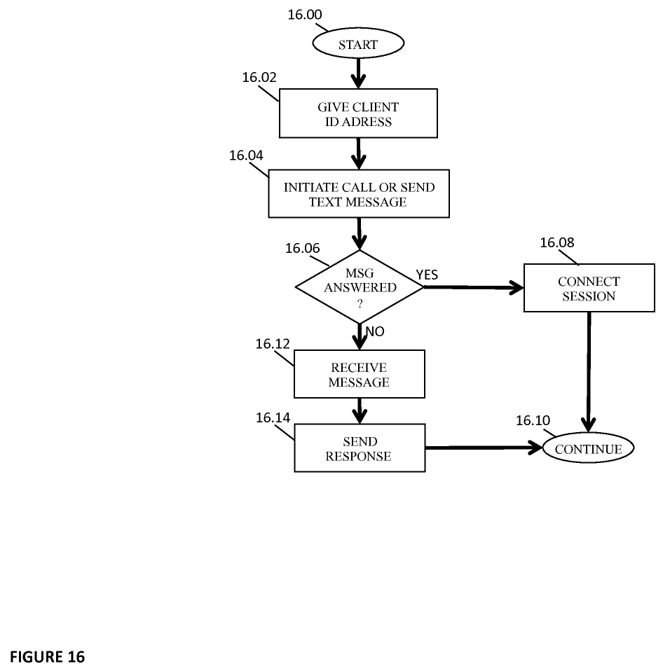

Referring now generally to the Figures, and particularly to FIG. 16, FIG. 16 is a flowchart of a yet further aspect of the invented method whereby an exemplary first contact 108 receives an automated custom response message RESP.001-RESP.N. In step 16.02 the contact 108 inputs the contact identification address CON.ID.001-CON.ID.N for the client 102. In step 16.04, the contact 108 initiates a communication 117 with the client 102, which communication 117 may optionally be, but is not limited to, a telephone call 113, and/or a text message 121 and/or an email transmission 122. In step 16.06 the contact 108 determines whether the communication 117 was answered. When the determination in step 16.06 is positive, the contact 108 connects the communication session, and proceeds to step 16.10, wherein the contact 108 continues to alternate processes. In the alternative, when the determination in step 16.06 is negative, the contact 108 advances to step 16.12, wherein the custom response message RESP.001-RESP.N is received. The contact 108 subsequently sends a response message in step 16.14, then proceeds to step 16.10, wherein the contact 108 continues to alternate processes.

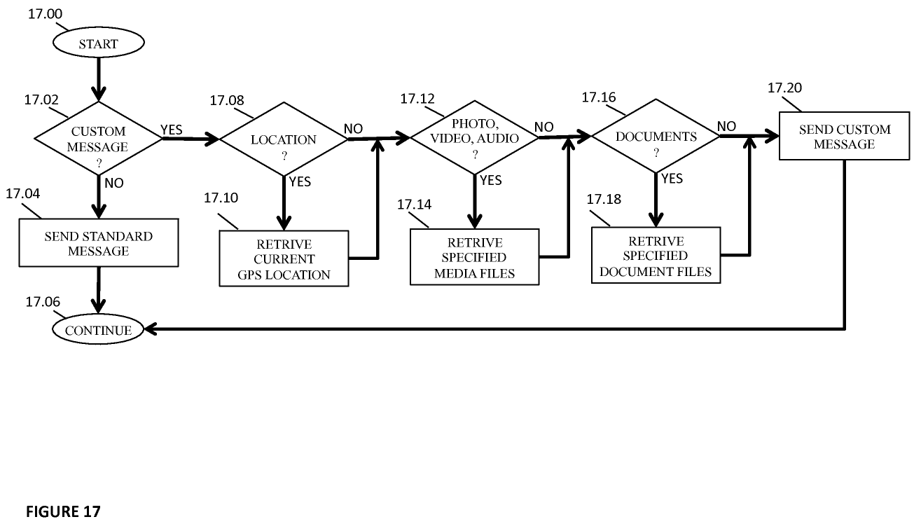

Referring now generally to the Figures, and particularly to FIG. 17, FIG. 17 is a flowchart of a yet further aspect of the invented method whereby a custom response message RESP.001-RESP.N may optionally be populated with attached media files 128. In step 17.02, the communications device 104 determines whether to transmit a custom response message RESP.001-RESP.N to a contact identification address CON.ID.001-CON.ID.N associated with an incoming communication. When the determination in step 17.02 is negative, the communications device 104 sends the standard, general response message MSG.GEN.001-MSG.GEN.N in step 17.04. The communications device 104 then continues to alternate processes in step 17.06. When the determination in step 17.02 is positive, the communications device 104 determines in step 17.08 whether to attach GPS location data GPS.001-GPS.N to the custom response message RESP.001-RESP.N. When the determination in step 17.08 is positive, the communications device 104 retrieves the current GPS location data GPS.LOC.001-GPS.LOC.N, and attaches the current GPS location data GPS.LOC.001-GPS.LOC.N to the custom response message RESP.001-RESP.N. The communications device 104 proceeds either from a negative determination in step 17.08, or from the execution of step 17.10 to step 17.12. In step 17.12 the communications device 104 determines whether to attach one or more photo files 130, and/or one or more video files 132, and/or one or more audio files 134 to the custom response message RESP.001-RESP.N. When the determination in step 17.14 is positive, the communications device 104 retrieves the specified media files 128 and attaches the specified media files 128 to the custom response message RESP.001-RESP.N in step 17.14. The communications device 104 proceeds either from the execution of step 17.14, or from a negative determination in step 17.12 to step 17.16. In step 17.16 the communications device 104 determines whether to attach document files 136 to the custom response message RESP.001-RESP.N. When the determination in step 17.16 is positive, the communications device 104 retrieves the specified document files 136 and attaches the specified document files 136 to the custom response message RESP.001-RESP.N. The communications device 104 proceeds either from an execution of step 17.18, or from a negative determination in step 17.16 to step 17.20. In step 17.20 the communications device 104 transmits the custom response message RESP.001-RESP.N to the contact identification address CON.ID.001-CON.ID.N with which the incoming communication 117 was associated. The communications device 104 then advances to step 17.06 and continues to alternate processes.

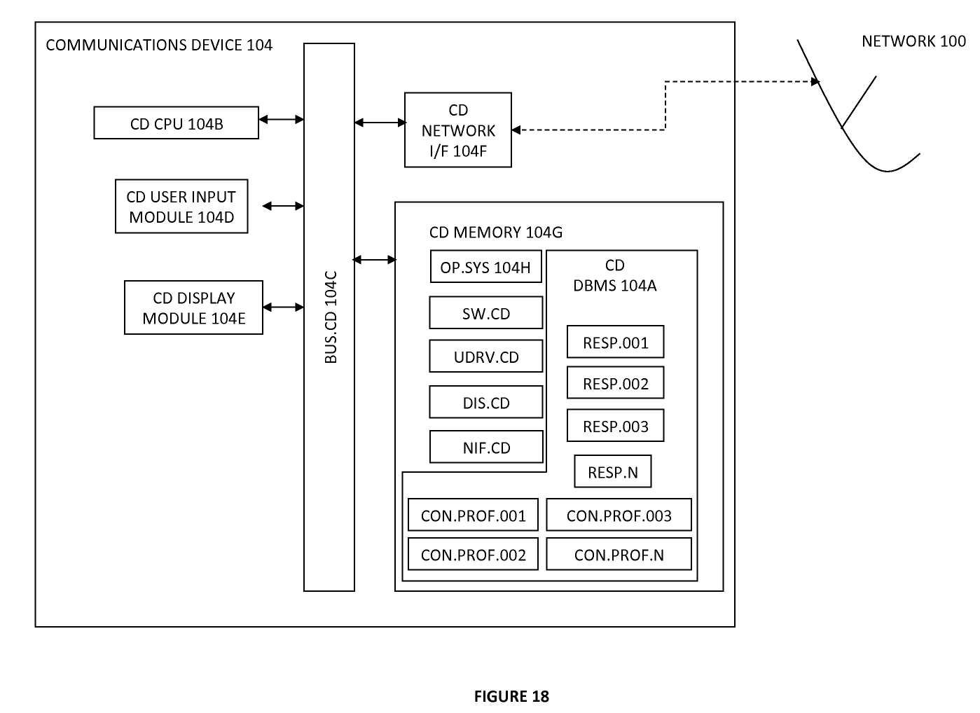

Referring now generally to the Figures, and particularly to FIG. 18, FIG. 18 is a block diagram of the communications device 104 of FIG. 1. A communications device system server operating system software OP.SYS 104H of the communications device 104 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™, VISTA™ or WINDOWS 7 ™ operating system as marketed by Microsoft Corporation of Redmond, Wash.; or the MAC OS X operating system or iPhone G4 OS™ as marketed by Apple, Inc. of Cupertino, Calif.

The communications device 104 further includes an communications device central processing unit 104B (“CPU 104B”) that is bi-directionally communicatively coupled by an communications device internal communications bus 104C with (a.) an optional communications device user input module 104D that accepts input, e.g., information and commands, from a user, (b.) an optional communications device video display module 104E that provides visual information rendering output, (c.) an communications device network interface 104F that bi-directionally communicatively couples the communications device 104 with the server 106 and with the client 102.

The communications device 104 further contains a communications device memory 104G. Stored within the communications device system memory 104G is a communications device server software SW.CD, a communications device user module driver UDRV.CD, an optional communications device display driver DIS.CD, a communications device network interface driver NIF.CD enables the communications device network interface 104F to bi-directionally communicatively couple the communications device 104 with the client 102 and the server 106.

The communications device server software SW.CD enables the communications device 104 to execute, perform and instantiate aspects of the invented method as disclosed within FIGS. 2, 5, 8, 11, and 14 and accompanying descriptions. The communications device user input module driver UDRV.CD enables the communications device user module 104D to input information and commands entered by a user 115 into the communications device 104. The communications device display driver DIS.CD enables the communications device 104 to visually render information by means of the communications device video display module 104E. The communications device network NIF.CD enables the communications device network interface module 104F to bi-directionally communicate with the client 102 and the server 106.

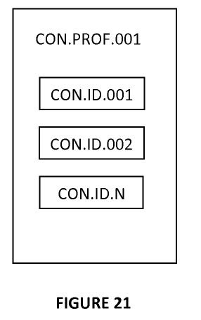

Within the communications device DBMS 104A, there are a plurality of recorded responses RESP.001, RESP.002, RESP.003 and RESP.N. The recorded responses RESP.001-RESP.N may be in the form of an audio recording, a video recording, a textual message, and/or a document, as disclosed in FIGS. 2 through 17, and accompanying descriptions. Further contained within the communications device DBMS 104A are a plurality of contact profiles CON.PROF.001, CON.PROF.002, CON.PROF.003 and CON.PROF.N. Each contact profile CON.PROF.001-CON.PROF.N may contain a plurality of contact identification addresses CON.ID.001-CON.ID.N, as presented in FIG. 21.

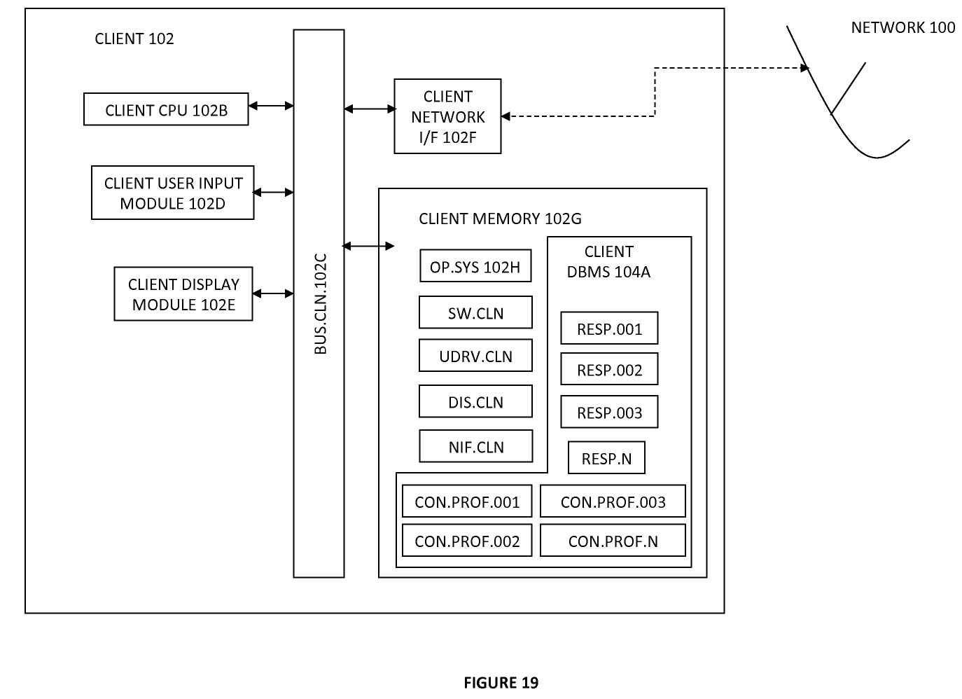

Referring now generally to the Figures, and particularly to FIG. 19, FIG. 19 is a block diagram of the client 102 of FIG. 1. A client system server operating system software OP.SYS 102H of the client 102 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™, VISTA™ or WINDOWS 7 ™ operating system as marketed by Microsoft Corporation of Redmond, Wash.; or the MAC OS X operating system or iPhone G4 OS™ as marketed by Apple, Inc. of Cupertino, Calif.

The client 102 further includes an client central processing unit 102B (“CPU 102B”) that is bi-directionally communicatively coupled by an client internal communications bus 102C with (a.) an optional client user input module 102D that accepts input, e.g., information and commands, from a user, (b.) an optional client video display module 102E that provides visual information rendering output, (c.) an client network interface 102F that bi-directionally communicatively couples the client 102 with the server 106 and with the communications device 104.

The client 102 further contains a client memory 102G. Stored within the client system memory 102G is a client server software SW.CLN, a client user module driver UDRV.CLN, an optional client display driver DIS.CLN, a client network interface driver NIF.CLN enables the client network interface 102F to bi-directionally communicatively couple the client 102 with the communications device 104 and the server 106.

The client server software SW.CLN enables the client 102 to execute, perform and instantiate aspects of the invented method as disclosed within FIGS. 3, 6, 9, and 12 and accompanying descriptions. The client user input module driver UDRV.CLN enables the client user module 102D to input information and commands entered by a user 115 into the client 102. The client display driver DIS.CLN enables the client 102 to visually render information by means of the client video display module 102E. The client network NIF.CLN enables the client network interface module 102F to bi-directionally communicate with the communications device 104 and the server 106.

Within the client DBMS 102A, there are a plurality of recorded responses RESP.001, RESP.002, RESP.003 and RESP.N. The recorded responses RESP.001-RESP.N may be in the form of an audio recording, a video recording, a textual message, and/or a set of profile information, as disclosed in FIGS. 2 through 17, and accompanying descriptions. Further contained within the server DBMS 106A are a plurality of contact profiles CON.PROF.001, CON.PROF.002, CON.PROF.003 and CON.PROF.N. Each contact profile CON.PROF.001-CON.PROF.N may contain a plurality of contact identification addresses CON.ID.001-CON.ID.N, as presented in FIG. 21.

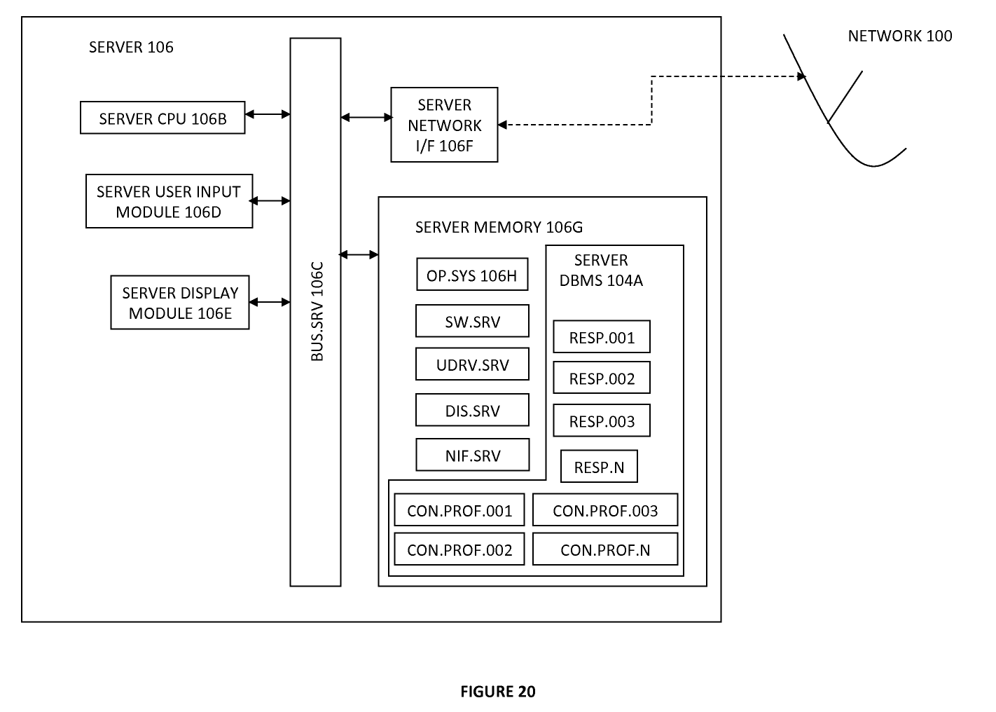

Referring now generally to the Figures, and particularly to FIG. 20, FIG. 20 is a block diagram of the server 106 of FIG. 1. A server system server operating system software OP.SYS 106H of the server 106 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™, VISTA™ or WINDOWS 7 ™ operating system as marketed by Microsoft Corporation of Redmond, Wash.; or the MAC OS X operating system or iPhone G4 OS™ as marketed by Apple, Inc. of Cupertino, Calif.

The server 106 further includes an server central processing unit 106B (“CPU 106B”) that is bi-directionally communicatively coupled by an server internal communications bus 106C with (a.) an optional server user input module 106D that accepts input, e.g., information and commands, from a user, (b.) an optional server video display module 106E that provides visual information rendering output, (c.) an server network interface 106F that bi-directionally communicatively couples the server 106 with the server 106 and with the communications device 104.

The server 106 further contains a server memory 106G. Stored within the server system memory 106G is a server software SW.SRV, a server user module driver UDRV.SRV, an optional server display driver DIS.SRV, a server network interface driver NIF.SRV enables the server network interface 106F to bi-directionally communicatively couple the server 106 with the communications device 104 and the server 102.

The server software SW.SRV enables the server 106 to execute, perform and instantiate aspects of the invented method as disclosed within FIGS. 4, 7, 10, and 13 and accompanying descriptions. The server user input module driver UDRV.SRV enables the server user module 106D to input information and commands entered by a user 115 into the server 106. The server display driver DIS.SRV enables the server 106 to visually render information by means of the server video display module 106E. The server network NIF.SRV enables the server network interface module 106F to bi-directionally communicate with the server 102 and the server 104.

Within the server DBMS 106A, there are a plurality of recorded responses RESP.001, RESP.002, RESP.003 and RESP.N. The recorded responses RESP.001-RESP.N may be in the form of an audio recording, a video recording, a textual message, and/or a set of profile information, as disclosed in FIGS. 2 through 17, and accompanying descriptions. Further contained within the server DBMS 106A are a plurality of contact profiles CON.PROF.001, CON.PROF.002, CON.PROF.003 and CON.PROF.N. Each contact profile CON.PROF.001-CON.PROF.N may contain a plurality of contact identification addresses CON.ID.001-CON.ID.N, as presented in FIG. 21.

Referring now generally to the Figures, and particularly to FIG. 21, FIG. 21 is a block diagram of an exemplary first contact profile CON.PROF.001, wherein the exemplary first contact profile includes a plurality of contact identification address CON.ID.001-CON.ID.N. Each of the plurality of contact identification address CON.ID.001-CON.ID.N may be, but are not limited to, telephone numbers, email addresses, text messenger identifiers, and/or VOIP identifiers.

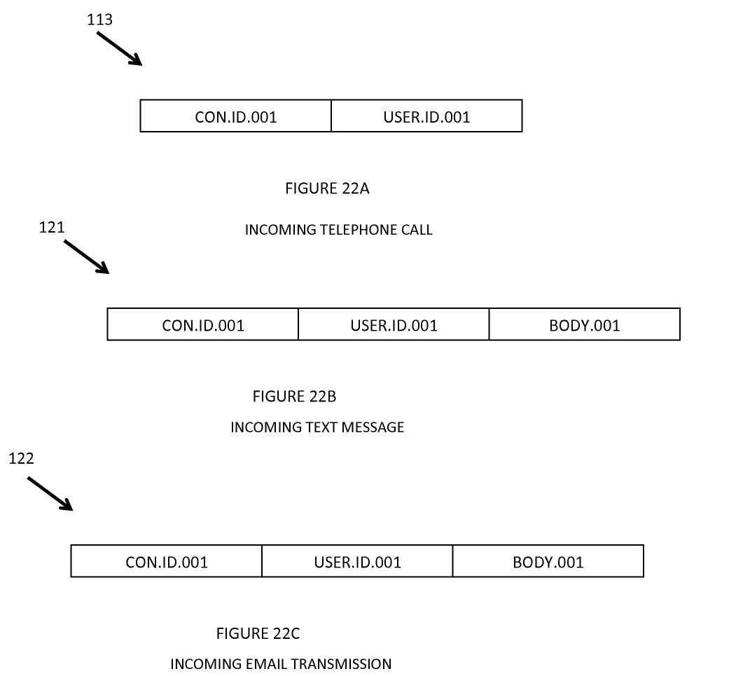

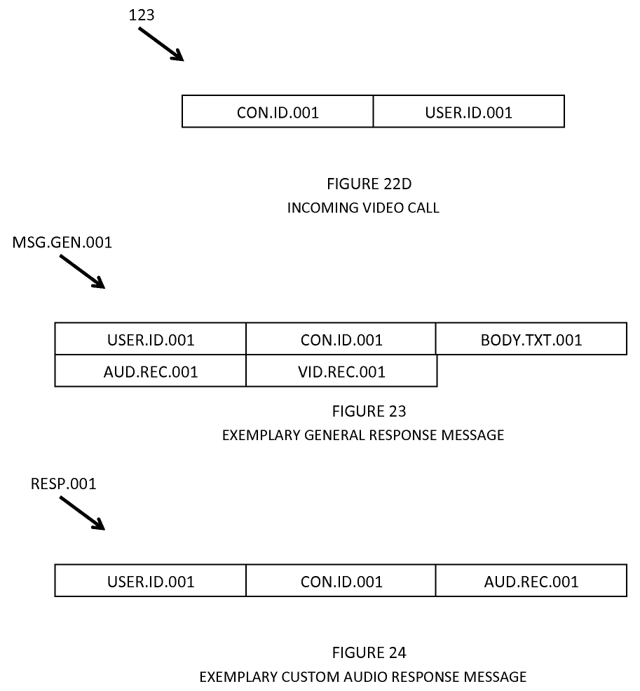

Referring now generally to the Figures, and particularly to FIGS. 22A-22D, FIGS. 22A-22D are block diagrams of exemplary incoming communications 117, wherein the exemplary incoming communications 117 may include, but are not limited to, telephone calls 113, text messages 121, email transmissions 122, and/or video calls 123. The exemplary first telephone call 113 includes the first contact identification address CON.ID.001 as the sending address, and a first user identification address USER.ID.001 as the receiving address. The exemplary first incoming text message 121 includes the first contact identification address CON.ID.001 as the sending address, a first user identification address USER.ID.001 as the receiving address, and the text-containing body BODY.001 of the text message 121. The exemplary incoming email transmission 122 includes the first contact identification address CON.ID.001 as the sending address, a first user identification address USER.ID.001 as the receiving address and the text-containing body BODY.001 of the email transmission 122. The exemplary first video call 123 includes the first contact identification address CON.ID.001 as the sending address, and a first user identification address USER.ID.001 as the receiving address.

Referring now generally to the Figures, and particularly to FIG. 23, FIG. 23 is a block diagram of an exemplary first general response message MSG.GEN.001. The exemplary first general response message MSG.GEN.001 includes, but is not limited to, the first user identification address USER.ID.001 as the sending address, the first contact identification address CON.ID.001 as the receiving address, the text-containing body BODY.001 of the first general response message MSG.GEN.001, and/or an audio recording AUD.REC.001 from the user 115, and/or a video recording VID.REC.001 from the user 115.

Referring now generally to the Figures, and particularly to FIG. 24, FIG. 24 is a block diagram of an exemplary first custom audio response message RESP.001. The first custom audio response message RESP.001 includes, but is not limited to, the first user identification address USER.ID.001 as the sending address, the first contact identification address CON.ID.001 as the receiving address, a custom audio recording AUD.REC.001 from the user 115.

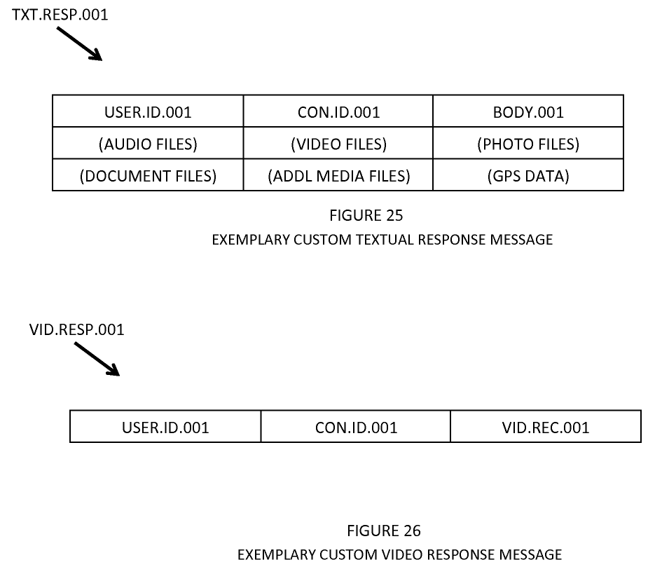

Referring now generally to the Figures, and particularly to FIG. 25, FIG. 25 is a block diagram of an exemplary first custom textual response message TXT.RESP.001, with optional audio file attachment(s) 134, photo file attachment(s) 130, video file attachment(s) 132, document file attachment(s) 136 and/or attached GPS location data GPS.001. The exemplary first custom textual response message TXT.RESP.001 further includes the first user identification address USER.ID.001 as the sending address, the first contact identification address CON.ID.001 as the receiving address, and a text-containing body BODY.001. Referring now generally to the Figures, and particularly to FIG. 26, FIG. 26 is a block diagram of an exemplary first custom video response message VID.RESP.001. The first custom video response message VID.RESP.001 includes, but is not limited to, the first user identification address USER.ID.001 as the sending address, the first contact identification address CON.ID.001 as the receiving address, a custom video recording VID.REC.001 from the user 115.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible configurations or aspects of the Present Invention. The examples given should only be interpreted as illustrations of some of the preferred configurations or aspects of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the present invention as disclosed and claimed should, therefore, be determined with reference to the knowledge of one skilled in the art and in light of the disclosures presented above.

I claim:

1. A computer-implemented method comprising:
in a communications device, recording a network identifier;
associating in the communications device a response message with the network identifier;
receiving a connection request by the communications device, the connection request associating the network identifier as the connection request source;
the communications device opening a communications session in accordance with the connection request; and
the communications device transmitting the response message to the connection request source address.

2. The computer-implemented method of claim 1, wherein the network identifier is a telephone number.

3. The computer-implemented method of claim 1, wherein the network identifier is a text message address.

4. The computer-implemented method of claim 1, wherein the network identifier is an email address.

5. The computer-implemented method of claim 1, wherein the network identifier is an instant messaging address.

6. The computer-implemented method of claim 1, wherein the response message comprises text data.

7. The computer-implemented method of claim 1, wherein the response message comprises digitized audio data.

8. The computer-implemented method of claim 1, wherein the response message comprises digitized visual data.

9. The computer-implemented method of claim 1, wherein the communications session is opened in accordance with the connection request only after the connection request is not accepted by a user for a prespecified period of time.

10. The computer-implemented method of claim 1, wherein the communications session is opened in accordance with the connection request while the communications device is engaging in an alternate communications session.

11. The computer-implemented method of claim 1, wherein the communications device comprises a digital telephone.

12. The computer-implemented method of claim 1, wherein the communications device comprises a wrist mounted interface.

13. The computer-implemented method of claim 1, wherein the communications device comprises a tablet computer.

14. The computer-implemented method of claim 1, wherein the communications device comprises a digital television.

15. The computer-implemented method of claim 1, further comprising the communications device transmitting the response message to the connection request source address in a separate and succeeding second communications session.

16. The computer-implemented method of claim 15, wherein the response message is transmitted as a text message.

17. The computer-implemented method of claim 15, wherein the response message is transmitted as an email message.

18. The computer-implemented method of claim 15, wherein the response message is transmitted as an audio data rendering.

19. A computer-implemented method comprising:
in a communications device, recording a network identifier;
associating in the communications device a response message with the network identifier;
receiving a connection request by the communications device, the connection request associating the network identifier as the connection request source;
the communications device initiating an alternate communications session in accordance with the connection request; and
the communications device transmitting the response message to the connection request source address.

20. A computer-implemented method comprising:
in a communications device, associating at least a first network address and a second network address with a same identity;
associating in the communications device a response message with the identity;
receiving a connection request by the communications device, the connection request associating either the first the network address or the second network address as the connection request source;
the communications device opening a communications session in accordance with the connection request; and
the communications device transmitting the response message to the connection request source address.

21. The computer-implemented method of claim 1, wherein the network identifier is a Nexys profile.

22. The computer-implemented method of claim 1, wherein the response message comprises video data.

23. The computer-implemented method of claim 1, wherein the response message comprises a photograph.

24. The computer-implemented method of claim 1, wherein the communications device comprises an implanted smart device.

25. The computer-implemented method of claim 14, wherein the response message is transmitted as a video data rendering.
